(19) United States
(12) Patent Application Publication
(10) Pub. No.: US 2018/0192771 A1
(43) Pub. Date: Jul. 12, 2018

(54) ARTICLE PLACING AREA AND CART DEVICE

(71) Applicant: OKAMURA CORPORATION, Yokohama-shi, Kanagawa (JP)

(72) Inventors: Nobutada TAKAHASHI, Yokohama-shi, Kanagawa (JP); Yoshihiro SAKAKIBARA, Yokohama-shi, Kanagawa (JP)

(21) Appl. No.: 15/740,260

(22) PCT Filed: Jul. 1, 2016
(86) PCT No.: PCT/JP2016/069591

§ 371 Date: Dec. 27, 2017

(30) Foreign Application Priority Data
Jul. 3, 2015 (JP) 2015-134787
Jul. 3, 2015 (JP) 2015-134797

(51) Int. Cl. A47B 31/00; A47B 96/02; B62B 3/02; B62B 3/00

(52) U.S. Cl. CPC A47B 31/00; A47B 96/027; A47B 96/024; A47B 2031/004; B62B 3/006; A47B 2031/003; B62B 3/02

(57) ABSTRACT

In a tray (2) of the present invention, an orientation of the tray (2) with respect to a cart body (3) is changed and the tray (2) is detachably attached to the cart body (3), and an aspect of an article accommodation region of the tray (2) when a front side of the tray (2) faces the support base (3b) side and the tray (2) is mounted on a tray support mechanism (4) and an aspect of an article accommodation region when a rear side of the tray (2) faces the support base (3b) side and the tray (2) is mounted on a tray support mechanism (4) are different from each other.

### TECHNICAL FIELD

The present invention relates to an article placing area and a cart device.

Priority is claimed on Japanese Patent Application Nos. 2015-134787 and 2015-134797, filed on Jul. 3, 2015, the contents of which are incorporated herein by reference.

### BACKGROUND ART

For example, Patent Documents 1 and 2 disclose cart devices capable of traveling which are used in offices, hospitals, or the like. This cart device includes a detachable tray or the like as an article placing area on which an article can be placed.

### CITATION LIST

### Patent Documents

[Patent Document 1] Japanese Unexamined Patent Application, First Publication No. 2013-17709

[Patent Document 2] Japanese Unexamined Patent Application, First Publication No. 2013-94281

[Patent Document 3] Japanese Patent No. 4943251

[Patent Document 4] Japanese Unexamined Patent Application, First Publication No. H3-173506

[Patent Document 5] Japanese Utility Model Publication No. 3114645

### SUMMARY OF INVENTION

### Technical Problem

Meanwhile, an article placed on an article placing area is not always one type. For example, a small medicine bottle or a large pot may be placed on an article placing area mounted on a cart device used in a hospital. In addition, for example, a thin small file and a thick large file may he placed on an article placing area mounted on a cart device used in an office. For this reason, for example, Patent Documents 3 to 5 disclose a fixture which has a tray having a depth, a width, and a horizontal depth thereof set according to characteristics such as a shape and a placement amount of a placed article to improve workability or the like.

Meanwhile, a person who places the article on the article placing area or takes out the article from the article placing area is not necessarily a person who runs the cart device. For example, the article may he transported to a person who needs the article by the cart device, and a person who needs the article himself/herself may takes out the article from the article placing area. That is, a person who delivers the article to the article placing area mainly delivering the article from which side of the article placing area depends on a use condition of the cart device or the like. However, in the fixtures disclosed in Patent Documents 3 to 5, the shape of the article placing area when viewed from a fixture body side is always fixed, and thus, in order to cope with a change of the use condition of the cart device or the like, it is necessary to prepare article placing areas having different shapes. Accordingly, and it is impossible to flexibly cope with change of use condition of the cart device or the like.

Meanwhile, Patent Documents 2 and 5 disclose a configuration in which usability is improved by installing article placing areas having different shapes in front and back with respect to a wagon or a cart device. However, in the configurations disclosed in Patent Documents 2 and 5, it is necessary to prepare article placing areas having a plurality of shapes. Accordingly, the number of types of molding dies or the like increases, and thus, the amount of capital investment increases, and the burden of the number of management steps and management cost increases.

The present invention is made in consideration of the above-described problems, and an object thereof is to further improve usability in a cart device on which an article placing area detachably attached to a fixture body is mounted.

### Solution to Problem

In order to achieve the above-described object, the present invention adopts the following means.

According to a first invention, there is provided a cart device which includes a fixture body capable of traveling and an article placing area which is detachably attached to the fixture body, in which an orientation of the article placing area with respect to the fixture body is changed and the article placing area is detachably attached to the fixture body, in which an aspect of an article accommodation region when the article placing area is mounted on the fixture body in a first orientation and an aspect of the article accommodation region when the article placing area is mounted on the fixture body in a second orientation different from the first orientation are different from each other, and the cart device includes the article placing area which is mounted on the fixture body in the first orientation and the article placing area which is mounted on the fixture body in the second orientation.

In the present invention, the article placing areas in which the aspects of the article accommodation regions are different from each other according to the orientations of the mounting are provided, and two or more article placing areas such as the article placing area mounted on the fixture body in the first orientation and the article placing area mounted on the fixture body in the second orientation are provided. Accordingly, even when the article is taken out from the article placing area in the same direction, it is possible to select an aspect in which the taking-out is easily performed, as the aspect of the article accommodation region. In addition, in the present invention, the use aspect of one article placing area can be changed, and thus, it is not necessary to prepare the article placing areas having a plurality of shapes, and it is possible to suppress the amount of capital investment by decreasing the number of molding dies or the like or it is possible to decrease the number of management steps or management cost.

According to a second invention, in the first invention, the fixture body includes a placing area support mechanism which supports the article placing area, and a support base which supports the placing area support mechanism and includes attached portions, to which the placing area support mechanism is attached, in front of the support base and behind the support base.

In the present invention, the attached portions to which the placing area support mechanisms detachably supporting the article placing areas are attached are provided in front of the support base and behind the support base. Accordingly, the placing area support mechanism, that is, the article placing area can be disposed in front of and behind the support base.

According to a third invention, in the second invention, the placing area support mechanism is attached to the attached portion such that a position of the placing area support mechanism in a vertical direction is able to be changed.

In the present invention, the position of the placing area support mechanism in the vertical direction can be changed by the attached portion. Therefore, according to the present invention, it is possible to arbitrarily change the position of the placing area support mechanism with respect to the support base in the vertical direction.

According to a fourth invention, in the second or third invention, the cart device further includes a front article placing area which is the article placing area disposed in front of the support base and a rear article placing area which is the article placing area disposed behind the support base, in which a height position of an upper end portion of the front article placing area on the support base side and a height position of an upper end of the rear article placing area are set to be same as each other.

In the present invention, the height positions of the upper end positions of the front article placing area and the rear article placing area are set to be the same as each other. Accordingly, it is possible to easily deliver the article between the front article placing area and the rear article placing area.

According to a fifth invention, in any one of the first to fourth inventions, the article placing area includes a bottom plate having an upper surface which becomes a placing surface of an article, a front fall prevention portion which uprightly stands on a front edge portion of the bottom plate, and a rear fall prevention portion which uprightly stands on a rear edge portion of the bottom plate and has a height higher than the front fall prevention portion from the bottom plate.

In the present invention, two regions having the depths different from each other in the article accommodation region are formed by changing the heights of the front fall prevention portion and the rear fall prevention portion. Accordingly, a small article and a large article can be simultaneously accommodated stably. Moreover, the bottom plate can be flattened, and thus, it is possible to stably accommodate the article.

According to a sixth invention, in the fifth invention, the front fall prevention portion and the rear fall prevention portion are configured of a portion of a peripheral wall portion which uprightly stands along an edge portion of the bottom plate, and the peripheral wall portion includes a side wall having a portion which is connected to the front fall prevention portion and has the same height as a height of the front fall prevention portion and a portion which is connected to the rear fall prevention portion and has the same height as a height of the rear fall prevention portion.

According to the present invention, the side wall of the peripheral wall portion includes the portion which is connected to the front fall prevention portion and has the same height as the height of the front fall prevention portion and the portion which is connected to the rear fall prevention portion and has the same height as the height of the rear fall prevention portion. Accordingly, in the vicinities of the front fall prevention portion and the rear fall prevention portion, the side wall does not protrude upward from the front fall prevention portion and the rear fall prevention portion. As a result, it is possible to prevent the article from falling from the entire peripheral wall portion without damaging workability of putting the article in the article accommodation region or taking the article out therefrom. Accordingly, it is possible to accommodate the article more stably.

According to a seventh invention, there is provided an article placing area on which an article is able to be placed, in which an orientation of the article placing area with respect to a fixture body is changed and the article placing area is detachably attached to the fixture body, and an aspect of an article accommodation region when the article placing area is mounted on the fixture body in a first orientation and an aspect of the article accommodation region when the article placing area is mounted on the fixture body in a second orientation different from the first orientation are different from each other.

In the present invention, the orientation of the article placing area with respect to the fixture body is changed and the article placing area is detachably attached to the fixture body. Moreover, in the present invention, the aspect of the article accommodation region when the article placing area is mounted on the fixture body in the first orientation and the aspect of the article accommodation region when the article placing area is mounted on the fixture body in the second orientation different from the first orientation are different from each other. Accordingly, even when the article is delivered to the article placing area in the same direction, workability of delivering the article is changed in the case where the article placing area is mounted on the fixture body in the first orientation and in the ease where the article placing area is mounted on the fixture body in the second orientation. Therefore, according to the present invention, it is possible to arbitrarily change the use aspect of one article placing area according to the situations.

According to an eighth invention, in the seventh invention, a front side or a rear side of the article placing area is detachably attached to the fixture body toward the fixture body, and a depth of a front accommodation region which is a region on the front side of the article accommodation region and a depth of a rear accommodation region which is a region on the rear side of the article accommodation region are different from each other.

According to the present invention, the two regions (front accommodation region and rear accommodation region) having the depths different from each other are provided, and thus, it is possible to simultaneously accommodate a small article and a large article stably.

According to a ninth invention, in the eighth invention, the article placing area includes a bottom plate having an upper surface which becomes a placing surface of an article, a front fall prevention portion which uprightly stands on a front edge portion of the bottom plate, and a rear fall prevention portion which uprightly stands on a rear edge portion of the bottom plate and has a height higher than the front fall prevention portion from the bottom plate.

According to the present invention, the two regions (front accommodation region and rear accommodation region) having the depths different from each other are formed by changing the heights of the front fall prevention portion and the rear fall prevention portion. Accordingly, it is possible to flatten the bottom plate. Therefore, it is possible to stably accommodate the article.

According to a tenth invention, in the ninth invention, the front fall prevention portion and the rear fall prevention portion are configured of a portion of a peripheral wall portion which uprightly stands along an edge portion of the bottom plate.

According to the present invention, the peripheral wall portion uprightly stands along the edge portion of the bottom plate, and thus, it is possible to prevent the article from falling from the entire region around the bottom plate. Therefore, it is possible to stably accommodate the article.

According to an eleventh invention, in the tenth invention, a flange is formed on an upper end of the peripheral wall portion.

According to the present invention, the flange is formed on the upper end of the peripheral wall portion, and thus, compared to a case where the flange is not provided and the upper end of the peripheral wall portion is thin, it is possible to soften a feeling of a worker when the worker's fingers come into contact with the upper end of the peripheral wall portion to put the article in the tray or take out the article from the tray. In addition, according to the present invention, it is possible to improve the strength of the article placing area by the flange.

### Advantageous Effects of Invention

According to the present invention, even when the article is taken out from the article placing area in the same direction, it is possible to select an aspect in which the taking-out is easily performed, as the aspect of the article accommodation region. Therefore, according to the present invention, it is possible to further improve usability in the cart device on which an article placing area detachably attached to the fixture body is mounted.

According to the present invention, it is possible to arbitrarily change the use aspect of one article placing area according to the situations. Therefore, according to the present invention, it is possible to flexibly change the aspect in the use condition in the article placing area detachably attached to the fixture body. In addition, the use aspect can be changed by one article placing area, and thus, it is not necessary to prepare the article placing areas having a plurality of shapes, and it is possible to suppress an amount of capital investment by decreasing the number of the molding dies or the like or it is possible to decrease the number of management steps or management cost.

### BRIEF DESCRIPTION OF DRAWINGS

FIG. 1A is a side view of an overall view of a cart device according to an embodiment of the present invention in a state in which an upper tray of two trays arranged vertically is installed facing forward and a lower tray thereof is installed facing rearward.

FIG. 1B is a perspective view of the overall view of the cart device according to the embodiment of the present invention in a state in which the upper tray of the two trays arranged vertically is installed facing forward and the lower tray thereof is installed facing rearward.

FIG. 2A is a side view of the overall view of the cart device according to the embodiment of the present invention in a state in which the upper tray of the two trays arranged vertically is installed facing forward and the lower tray thereof is installed facing rearward.

FIG. 2B is a perspective view of the overall view of the cart device according to the embodiment of the present invention in a state in which the upper tray of the two trays arranged vertically is installed facing forward and the lower tray thereof is installed facing rearward.

FIG. 3A is a perspective view when a tray included in the cart device according to the embodiment of the present invention is viewed from above.

FIG. 3B is a perspective view when the tray included in the cart device according to the embodiment of the present invention is viewed from below.

FIG. 4A is a bottom view of a three-sided view of the tray included in the cart device according to the embodiment of the present invention.

FIG. 4B is a side view of a three-sided view of the tray included in the cart device according to the embodiment of the present invention.

FIG. 4C is a front view of a three-sided view of the tray included in the cart device according to the embodiment of the present invention.

FIG. 5 is a perspective view including a cart body and a tray support mechanism in the cart device according to the embodiment of the present invention (a perspective view in which the tray is omitted).

FIG. 6A is a horizontal sectional view of a support base included in the cart device according to the embodiment of the present invention.

FIG. 6B is a front view of a support base included in the cart device according to the embodiment of the present invention.

FIG. 7 is a perspective view when the tray support mechanism included in the cart device according to the embodiment of the present invention is viewed from above in a state where the tray is removed.

FIG. 8 is a perspective view when the tray support mechanism included in the cart device according to the embodiment of the present invention is viewed from below in the state where the tray is removed.

FIG. 9 is a bottom view when the tray support mechanism included in the cart device according to the embodiment of the present invention is viewed from below in a state where the tray is attached.

FIG. 10 is a partially enlarged side view of a portion on the cart body side of the tray support mechanism included in the cart device according to the embodiment in the state where the tray is removed.

FIG. 11A is a perspective view of a lock member included in the cart device according to the embodiment of the present invention and is a perspective view when the cart device is viewed from the front side.

FIG. 11B is a perspective view of the lock member included in the cart device according to the embodiment of the present invention and is a perspective view when the cart device is viewed from the rear side.

FIG. 12A is a schematic view showing an operation when the tray is mounted on the tray support mechanism included in the cart device according to the embodiment of the present invention.

FIG. 12B is a schematic view showing the operation when the tray is mounted on the tray support mechanism included in the cart device according to the embodiment of the present invention.

FIG. 13A is a schematic view showing the operation when the tray is mounted on the tray support mechanism included in the cart device according to the embodiment of the present invention.

FIG. 13B is a schematic view showing the operation when the tray is mounted on the tray support mechanism included in the cart device according to the embodiment of the present invention.

FIG. 14A is a schematic view showing an operation when the tray support mechanism is detached from the cart body included in the cart device according to the embodiment of the present invention.

FIG. 14B is a schematic view showing the operation when the tray support mechanism is detached from the cart body included in the cart device according to the embodiment of the present invention.

FIG. 15A is a schematic view showing the operation when the tray support mechanism is detached from the cart body included in the cart device according to the embodiment of the present invention.

FIG. 15B is a schematic view showing the operation when the tray support mechanism is detached from the cart body included in the cart device according to the embodiment of the present invention.

FIG. 16 is a perspective view showing a modification example of the cart device according to the embodiment of the present invention.

FIG. 17 is a perspective view showing another modification example of the cart device according to the embodiment of the present invention.

FIG. 18A is a side view showing the entire cart device in the embodiment of the present invention showing an aspect in which two trays are mounted in different orientations.

FIG. 18B is a side view showing the entire cart device in the embodiment of the present invention showing an aspect in which two trays are mounted in different orientations.

FIG. 19 is a perspective view showing a modification example of the tray included in the cart device according to the embodiment of the present invention.

FIG. 20 is a perspective view showing another modification example of the tray included in the cart device according to the embodiment of the present invention.

FIG. 21 is a perspective view showing still another modification example of the tray included in the cart device according to the embodiment of the present invention.

FIG. 22 is a perspective view showing still another modification example of the tray included in the cart device according to the embodiment of the present invention.

FIG. 23 is a perspective view showing a shallow tray and a tray included in a modification example of the cart device according to the embodiment of the present invention.

FIG. 24 is a perspective view showing a shallow tray and a tray included in a modification example of the cart device according to the embodiment of the present invention.

### DESCRIPTION OF EMBODIMENTS

Hereinafter, an embodiment of a cart device according to the present invention will be described with reference to the drawings. Hereinafter, in the following drawings, a scale of each member is appropriately changed such that the member is shown to be a recognizable size.

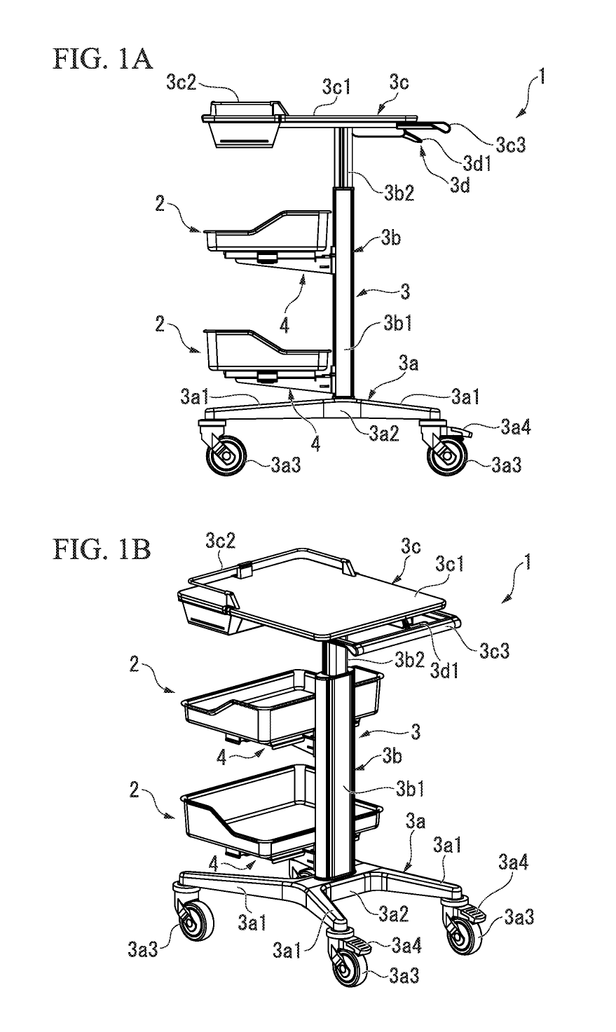

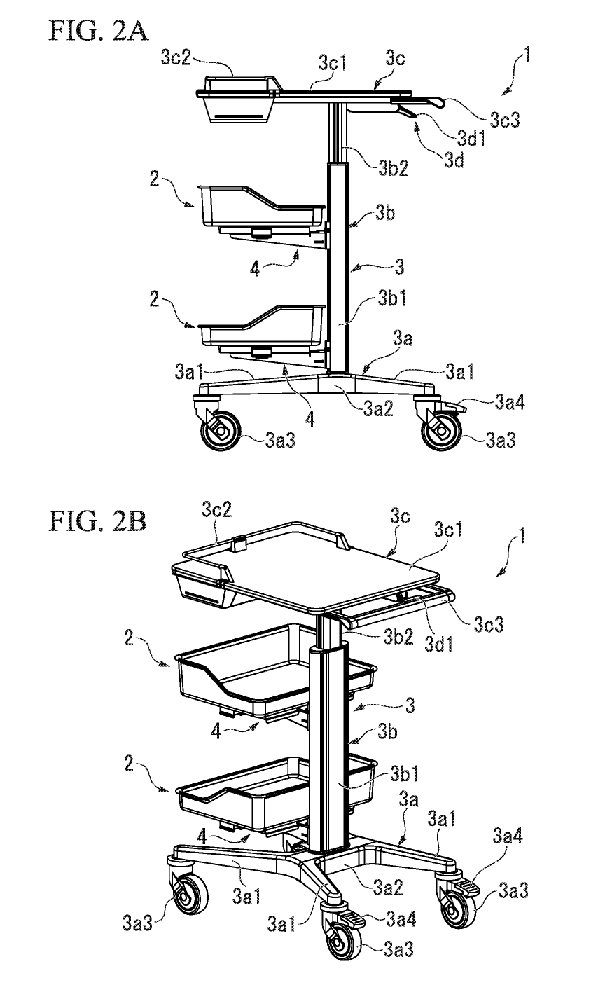

FIGS. 1A, 1B, 2A, and 2B are overall views of a cart device 1 of the present embodiment. FIGS. 1A and 1B are overall views of the cart device 1 in a state in which an upper tray of two trays 2 (article placing areas) arranged vertically is installed facing forward and a lower tray thereof is installed facing rearward, FIG. 1A is a side view, and FIG. 1B is a perspective view. In addition, FIGS. 2A and 2B are overall views of the cart device 1 in a state in which the lower tray of the two trays 2 (article placing areas) arranged vertically is installed facing forward and the upper tray thereof is installed facing rearward, FIG. 2A is a side view, and FIG. 2B is a perspective view. In addition, in the following descriptions, in the FIGS. 1A and 2A, a left side is referred to as a front side and a right side is referred to as a rear side.

The cart device 1 is a fixture which places and transports articles such as document files and drug bottles in offices or hospitals, and as shown in FIGS. 1A, 1B, 2A, and 2B, includes trays 2, a cart body 3, and tray support mechanisms 4 (placing area support mechanisms). In addition, in the present embodiment, a fixture body of the present invention is configured of the cart body 3 and the tray support mechanism 4.

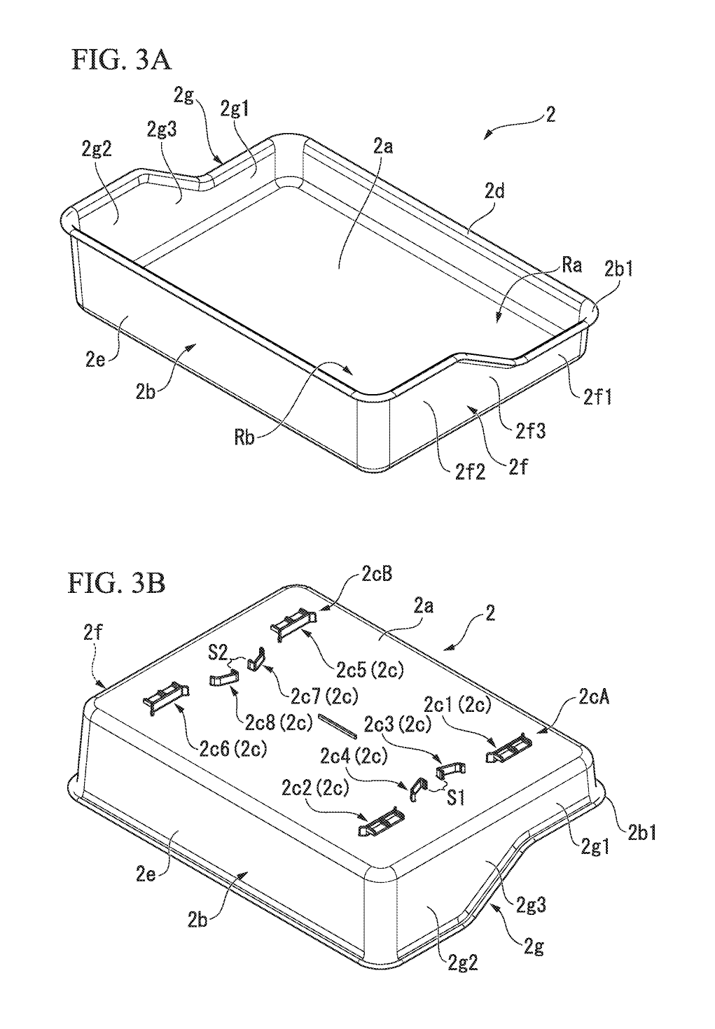

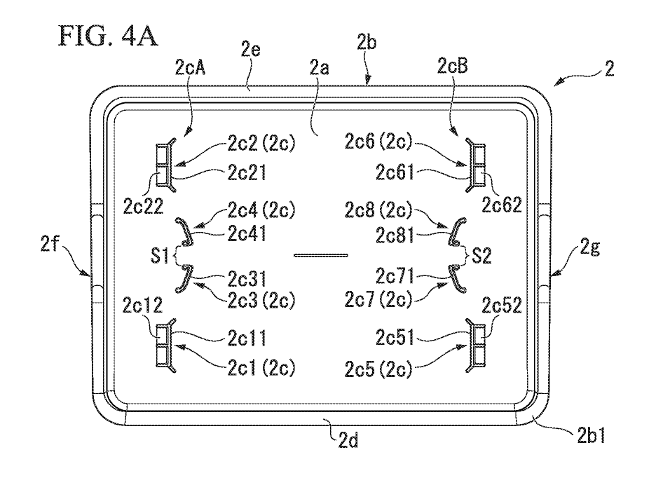

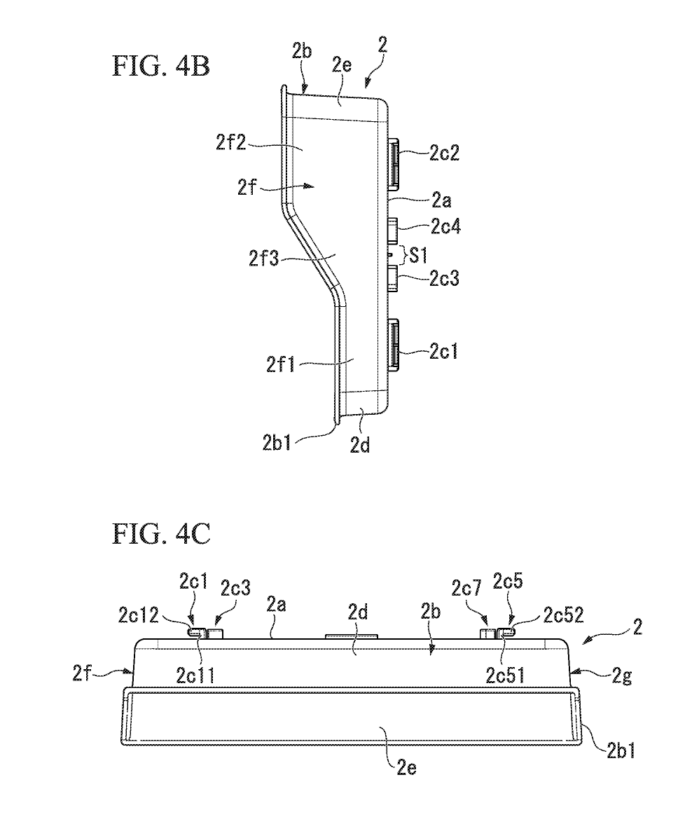

FIGS. 3A and 3B are perspective views of the tray 2, FIG. 3A is a perspective view when the tray 2 is viewed from above, and FIG. 3B is a perspective view when the tray 2 is viewed from below. In addition, FIGS. 4A to 4C are a three-sided view of the tray 2, FIG. 4A is a bottom view, FIG. 4B is a side view, and 4C is a front view. As shown in the drawings, the tray 2 is a bottom plate 2a, a peripheral wall portion 2b which uprightly stands on an edge portion of the bottom plate 2a, and protrusion portions 2c which are formed on a lower surface of the bottom plate 2a, and an article can be placed on the tray 2. In addition, in the following descriptions, for convenience of the descriptions, a side shown in FIG. 4C is referred to as a front side, and a side opposite to the front side is referred to as a rear side. Moreover, a direction in which the front side and the rear side are connected to each other is referred to as a depth direction, and a horizontal direction orthogonal to the depth direction is referred to as a width direction.

The bottom plate 2a is an article placing surface having a flat upper surface and is a plate-shaped portion which supports the placed article from below. In the present embodiment, as shown in FIGS. 3A, 3B, and 4A to 4C, the bottom plate 2a is formed in an approximately rectangular shape which is short in a depth direction and is long in a width direction.

The peripheral wall portion 2b is a wall portion which uprightly stands on the edge portion of the bottom plate 2a to surround the bottom plate 2a, and includes a front wall (front fall prevention portion) 2d which uprightly stands from a long side (that is, edge portion) on the front side of the bottom plate 2a, a rear wall (rear fall prevention portion) 2e which uprightly stands from a long side (that is, edge portion) on the rear side of the bottom plate 2a, a first side wall 2f which uprightly stands from a left side (first side in the width direction) of the bottom plate 2a, and a second side wall 2g which uprightly stands from a right side (second side in the width direction) of the bottom plate 2a.

The height of the front wall 2d is set to be lower than the height of the rear wall 2e.

That is, the height of the rear wall 2e is set to be higher than the height of the front wall 2d. Accordingly, an upper end of the front wall 2d is positioned to be lower than an upper end of the rear wall 2c. In addition, the first side wall 2f is connected to a left end of the front wall 2d and a left end of the rear wall 2e. Moreover, the second side wall 2g is connected to a right end of the front wall 2d and a right end of the rear wall 2e.

The first side wall 2f includes a front portion 2f1, a rear portion 2f2, and an intermediate portion 2f3. The front portion 2f1 is a portion which is connected to the front wall 2d and has the same height as that of the front wall 2d. The rear portion 2f2 is a portion which is connected to the rear wall 2c and has the same height as that of the rear wall 2e. The intermediate portion 2f3 is a portion which is disposed between the front portion 2f1 and the rear portion 2f2 and has an upper end which is inclined to be linearly connected to an upper end of the front portion 2f1 and an upper end of the rear portion 2f2.

The second side wall 2g includes a front portion 2g1, a rear portion 2g2, and an intermediate portion 2g3. The front portion 2g1 is a portion which is connected to the front wall 2d and has the same height as that of the front wall 2d. The rear portion 2g2 is a portion which is connected to the rear wall 2e and has the same height as that of the rear wall 2e. The intermediate portion 2g3 is a portion which is disposed between the front portion 2g1 and the rear portion 2g2 and has an upper end which is inclined to be linearly connected to an upper end of the front portion 2g1 and an upper end of the rear portion 2g2. In addition, as shown in FIG. 3A, the intermediate portion 2f3 of the first side wall 2f and the intermediate portion 2g3 of the second side wall 2g arc provided at the same location in the depth direction.

Moreover, a flange 2b1 is formed on an upper end of the peripheral wall portion 2b. The flange 2b1 is formed by bending an upper edge portion of the peripheral wall portion 2b outward. The width of the flange 2b1 in the horizontal direction is set to be thicker than the thickness of a region (a wall region below the flange 2b1) except for the flange 2b1 of the peripheral wall portion 2b.

In the tray 2 including the peripheral wall portion 2b, a region surrounded by the peripheral wall portion 2b becomes a region (article accommodation region) capable of accommodating an article. In addition, as shown in FIG. 3A, in the tray 2, the height of the peripheral wall portion 2b on the front side is low, and the height of the peripheral wall portion 2b on the rear side is high. Accordingly, the peripheral wall portion 2b is low on the front side (hereinafter, referred to as a front accommodation region Ra) of the article accommodation region of the tray 2, and thus, the article is easily put in the tray 2 or taken out from the tray 2 in the front accommodation region Ra and the article placed on the front accommodation region Ra is easily viewed. Accordingly, the front accommodation region Ra becomes a region suitable for accommodating a small article. Meanwhile, the peripheral wall portion 2b is high on the rear side (hereinafter, referred to as a rear accommodation region Rb) of the accommodation region of the tray 2, and thus, even when a tall article is inclined by traveling vibrations or the like of the cart device 1, the tall article can be supported by the peripheral wall portion 2b, and for example, the rear accommodation region Rb becomes a region suitable for accommodating a tall article stably.

In a case where the tray 2 is viewed from the front side, the front accommodation region Ra with a shallow depth is positioned on the front side and the rear accommodation region Rb with a deep depth is disposed on the rear side. Meanwhile, in a case where the tray 2 is viewed from the rear side, the rear accommodation region Rb with a deep depth is disposed on the front side and the front accommodation region Ra with a shallow depth is disposed on the rear side. That is, in the tray 2 of the present embodiment, by reversing an orientation of the tray 2, an aspect (a shape of the article accommodation region) of the article accommodation region when viewed in the same direction is changed. Accordingly, as shown in FIGS. 1A and 1B, the aspect of the article accommodation region in a case where the tray 2 is mounted such that the front side faces the cart body 3 side and the aspect of the article accommodation region in a case where the tray 2 is mounted such that the rear side faces the cart body 3 side are different from each other.

The protrusion portions 2c are portions which protrude downward from the lower surface of the bottom plate 2a. In the present embodiment, as shown in FIG. 4A, a plurality of protrusion portions 2c are formed. In addition, for convenience of description, the protrusion portions 2c are divided into a left protrusion group 2cA which is disposed on the left side of the tray 2 and a right protrusion group 2cB which is disposed on the right side of the tray 2.

As the protrusion portions 2c, the left protrusion group 2cA includes a front protrusion portion 2c1, a rear protrusion portion 2c2, a front center protrusion portion 2c3, and a rear center protrusion portion 2c4. As shown in FIG. 4A, the front protrusion portion 2c1, the rear protrusion portion 2c2, the front center protrusion portion 2c3, and the rear center protrusion portion 2c4 are approximately linearly arranged in the depth direction.

The front protrusion portion 2c1 includes a first hanging portion 2c11 which is hanged downward from the lower surface of the tray 2 and an extension portion 2c12 which protrudes from the lower end of the first hanging portion 2c11 toward the right side of the tray 2.

The extension portion 2c12 is an approximately rectangular plate portion in which a long side is horizontally disposed in a depth direction of the tray 2, a right side of the extension portion 2c12 is connected to a lower end of the first hanging portion 2c11, and thus, the extension portion 2c12 is disposed with a constant gap to the lower surface of the tray 2. As shown in FIG. 4A, the front protrusion portion 2c1 is disposed on the foremost side of the tray 2 among the protrusion portions of the left protrusion group 2cA.

The rear protrusion portion 2c2 is formed in the same shape as that of the front protrusion portion 2c1, and includes a first hanging portion 2c21 which is hanged downward from the lower surface of the tray 2 and an extension portion 2c22 which protrudes toward the right side of the tray 2 from the lower end of the first hanging portion 2c21. The extension portion 2c22 is an approximately rectangular plate portion in which a long side is horizontally disposed in the depth direction of the tray 2, a right side of the extension portion 2c12 is connected to a lower end of the first hanging portion 2c21, and thus, the extension portion 2c22 is disposed with a constant gap to the lower surface of the tray 2. The separation distance from the extension portion 2c22 to the lower surface of the tray 2 is set to be the same as a separation distance from the extension portion 2c12 of the front protrusion portion 2c1 to the lower surface of the tray 2. As shown in FIG. 4A, the rear protrusion portion 2c2 is disposed on the rearmost side of the tray 2 among the protrusion portions of the left protrusion group 2cA.

The front center protrusion portion 2c3 and the rear center protrusion portion 2c4 are disposed between the front protrusion portion 2c1 and the rear protrusion portion 2c2. In the front center protrusion portion 2c3 and the rear center protrusion portion 2c4, the front center protrusion portion 2c3 is disposed on the front side of the tray 2 and the rear center protrusion portion 2c4 is disposed on the rear side of the tray 2. A fitting gap S1 is formed between the front center protrusion portion 2c3 and the rear center protrusion portion 2c4, and an engagement protrusion (engagement protrusion) 4f described later included in the tray support mechanism 4 is fitted into the fitting gap S1.

The front center protrusion portion 2c3 is disposed to be slightly displaced to the center portion side of the tray 2 in the width direction with respect to the front protrusion portion 2c1 and the rear protrusion portion 2c2. The front center protrusion portion 2c3 has an inclined surface 2c31 which is inclined in the depth direction toward the front side of the tray 2. The inclined surface 2c31 is a surface which faces the center side of the tray 2 in the width direction to be continuous from the front side of the tray 2 toward the fitting gap S1. The inclined surface 2c31 guides the engagement protrusion 41′ when the front side of the main tray 2 faces the cart body 3 side and the tray 2 is attached and detached. Similarly to the front center protrusion portion 2c3, the rear center protrusion portion 2c4 is disposed to be slightly displaced to the center portion side of the tray 2 in the width direction with respect to the front protrusion portion 2c1 and the rear protrusion portion 2c2. The rear center protrusion portion 2c4 has an inclined surface 2c41 which is inclined in the depth direction toward the rear side of the tray 2. The inclined surface 2c41 is a surface which faces the center side of the tray 2 in the width direction to be continuous from the rear side of the tray 2 toward the fitting gap S1. The inclined surface 2c41 guides the engagement protrusion 4f when the rear side of the main tray 2 faces the cart body 3 side and the tray 2 is attached and detached. The front center protrusion portion 2c3 and the rear center protrusion portion 2c4 are symmetrical with respect to the center of the tray 2 in the depth direction.

As the protrusion portions 2c, the right protrusion group 2cB includes a front protrusion portion 2c5, a rear protrusion portion 2c6, a front center protrusion portion 2c7, and a rear center protrusion portion 2c8. The front protrusion portion 2c5, the rear protrusion portion 2c6, the front center protrusion portion 2c7, and the rear center protrusion portion 2c8 included in the right protrusion group 2cB are laterally symmetrical to those included in the left protrusion group 2cA.

That is, the front protrusion portion 2c5 is laterally symmetrical to the front protrusion portion 2c1 of the left protrusion group 2cA and includes a first hanging portion 2c51 and an extension portion 2c52. In addition, the rear protrusion portion 2c6 is laterally symmetrical to the rear protrusion portion 2c2 of the left protrusion group 2cA and includes a first hanging portion 2c61 and an extension portion 2c62. In addition, the front center protrusion portion 2c7 is laterally symmetrical to the front center protrusion portion 2c3 of the left protrusion group 2cA and includes an inclined surface 2c71. Moreover, the rear center protrusion portion 2c8 is laterally symmetrical to the rear center protrusion portion 2c4 of the left protrusion group 2cA and includes an inclined surface 2c81. In addition, a fitting gap S2 is formed between the front center protrusion portion 2c7 and the rear center protrusion portion 2c8, and the engagement protrusion 4f described later included in the tray support mechanism 4 is fitted into the fitting gap S2.

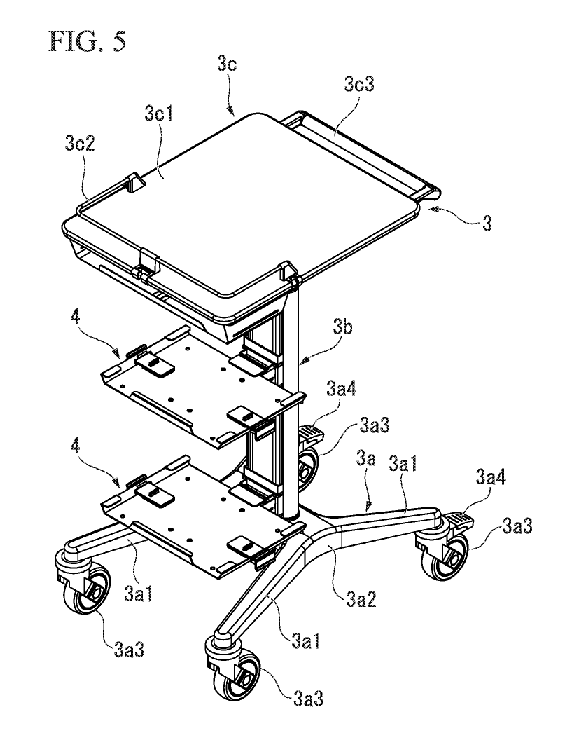

FIG. 5 is a perspective view (a perspective view in which the trays 2 are omitted) including the cart body 3 and the tray support mechanisms 4. The cart body 3 includes a leg portion 3a, a support base 3b, a top plate unit 3c, and a lifting/lowering operation portion 3d.

The leg portion 3a includes four linear leg rods 3a1, a first base portion 3a2 to which roots of the leg rod 3a1 are connected, a caster 3a3 attached to a tip portion of each leg rod 3a1, and lock portions 3a4 which lock the casters 3a3. The casters 3a3 of the leg portion 3a roll on the floor surface in a state of being abutting on the floor surface, and thus, the cart device 1 can travel. In addition, the casters 3a3 are locked by the lock portions 3a4, and thus, the movement of the cart device 1 is regulated.

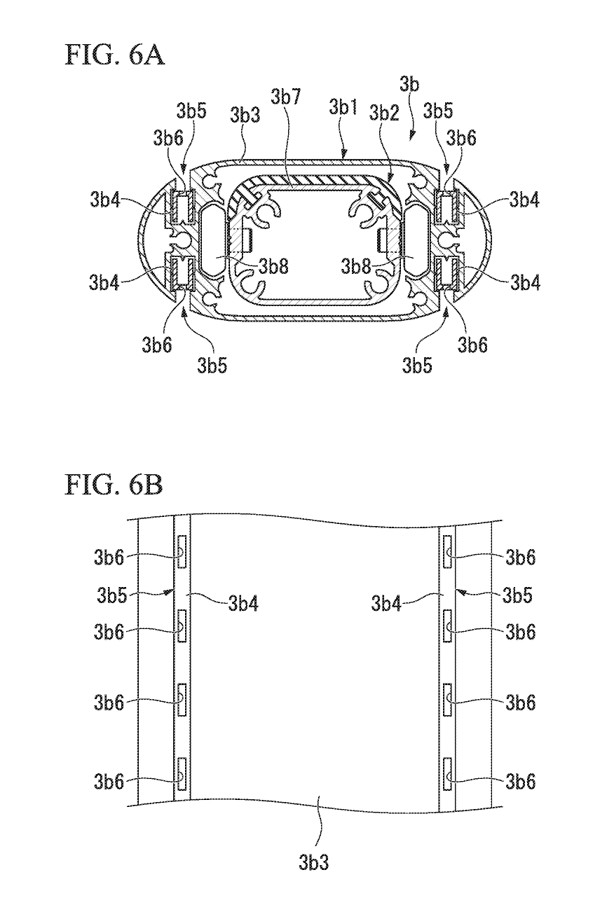

FIG. 6A is a horizontal sectional view of the support base 3b and FIG. 6B is a front view of the support base 3b. As shown in FIG. 6A, the support base 3b includes an outer column unit 3b1 and an inner column unit 3b2. The outer column unit 3b1 includes an outer 3b3 which is a hollow columnar portion uprightly standing on the first base portion 3a2 of the leg portion 3a, and shelf posts 3b4 which are fixed to the outer 3b3. In the outer 3b3, two first groove portions 3b5 arc formed on each of the front side and the rear side of the cart device 1. The two first grooves portions 3b5 are formed to vertically extend in a state of being parallel to each other. Each of the shelf posts 3b4 is fitted to each of the first groove portions 3b5 of the outer 3b3. That is, in the present embodiment, two shelf posts 3b4 are provided on each of the front side and the rear side of the cart device 1, and thus, total of four shelf posts 3b4 are provided. In each shelf post 3b4, locking holes 3b6 are formed at a constant pitch in the vertical direction. The locking holes 3b6 are portions into which locking claws 4g3 described later included in the tray support mechanism 4 are inserted. By locking the tray support mechanism 4 to a portion of the plurality of locking holes 3b6, it is possible to dispose the tray support mechanism 4 at an arbitrary height.

The inner column unit 3b2 includes a hollow columnar portion 3b7 which is inserted into the outer 3b3 of the outer column unit 3b1 and has an upper end to which the top plate unit 3c is fixed, and rollers 3b8 which are pivoted by side portions of the columnar portion 3b7 and abut an inner wall surface of the outer 3b3 of the outer column unit 3b1. The inner column unit 3b2 can vertically move inside the outer 3b3 of the outer column unit 3b1 by rolling the rollers 3b8. In a case where the inner column unit 3b2 largely protrudes upward from the outer column unit 3b1, the entire support base 3b extends, and thus, the top plate unit 3c is disposed at a high position. Meanwhile, in a case where most of the inner column unit 3b2 is accommodated in the outer column unit 3b1, the entire support base 3b is contracted, and thus, the top plate unit 3c is disposed at a low position.

The top plate unit 3c includes a top plate 3c1, a fall prevention bar 3c2, and a handle 3c3. The top plate 3c1 is an approximately rectangular plate member having an upper surface which becomes an article placing surface, and is fixed to an upper end of a columnar portion 3b7 of the inner column unit 3b2. The fall prevention bar 3c2 is supported on the front side of the top plate unit 3c on the top plate unit 3c and is bent along the edge portion of the top plate unit 3c. For example, this fall prevention bar 3c2 prevents the article placed on the top plate 3c1 from sliding on the top plate 3c1 and falling from the front side of the top plate 3c 1 when the cart device 1 stops from a traveling state thereof. The handle 3c3 is provided to further protrude rearward from the rear edge portion of the top plate 3c1. The handle 3c3 is a portion which is gripped by a worker when the cart device 1 travels.

The lifting/lowering operation portion 3d includes an operation lever 3d1 and a lock mechanism (not shown). The operation lever 3d1 is disposed below the handle 3c3 (refer to FIGS. 1A, 1B, 2A, and 2B), and the lock of the inner column unit 3b2 is released by the lock mechanism by operating the operation lever 3d1. The lock mechanism fixes the inner column unit 3b2 to the outer column unit 3b1 and releases the lock only in a case where the operation lever 3d1 is operated. It is possible to dispose the top plate 3c1 at an arbitrary height by the lifting/lowing operation portion 3d.

As shown FIG. 5, in the present embodiment, two tray support mechanisms 4 are provided with respect to the cart body 3. The tray support mechanisms 4 are disposed to be separated from each other in the vertical direction, and each thereof detachably supports the tray 2. In addition, the tray support mechanisms 4 have the same configuration except that the disposition heights thereof are different from each other, and thus, in the following descriptions, one tray support mechanism 4 is described.

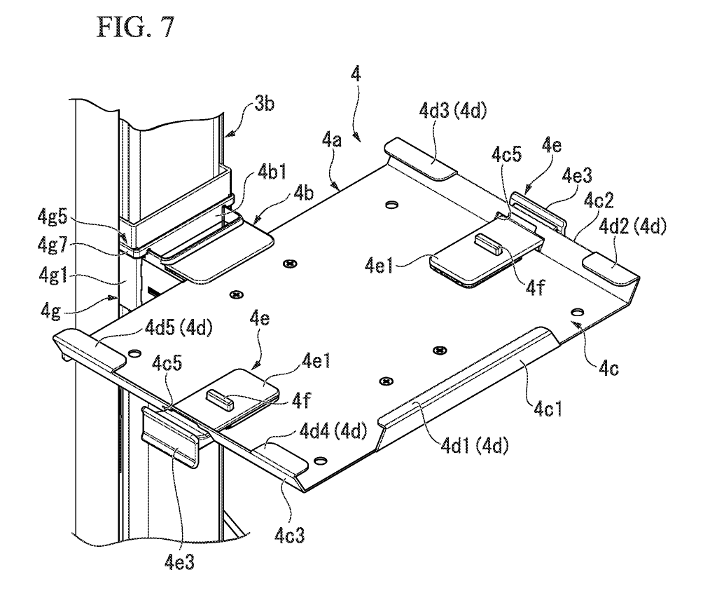

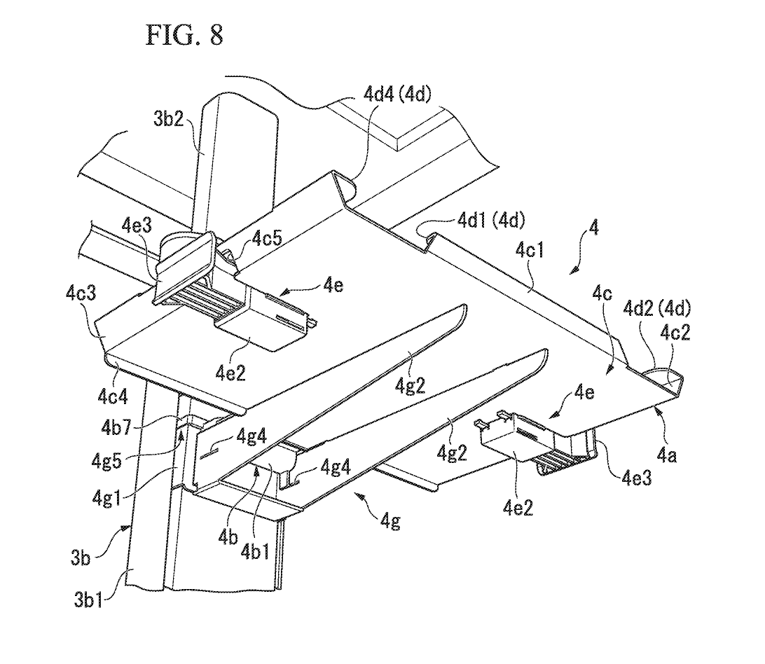

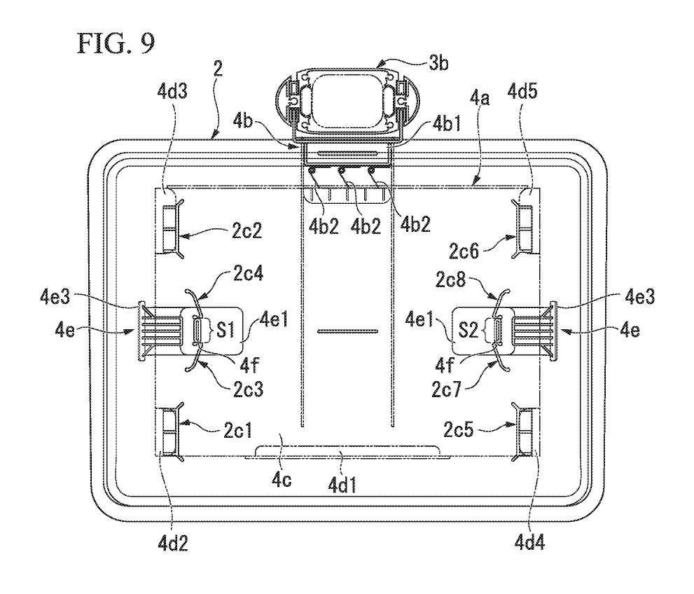

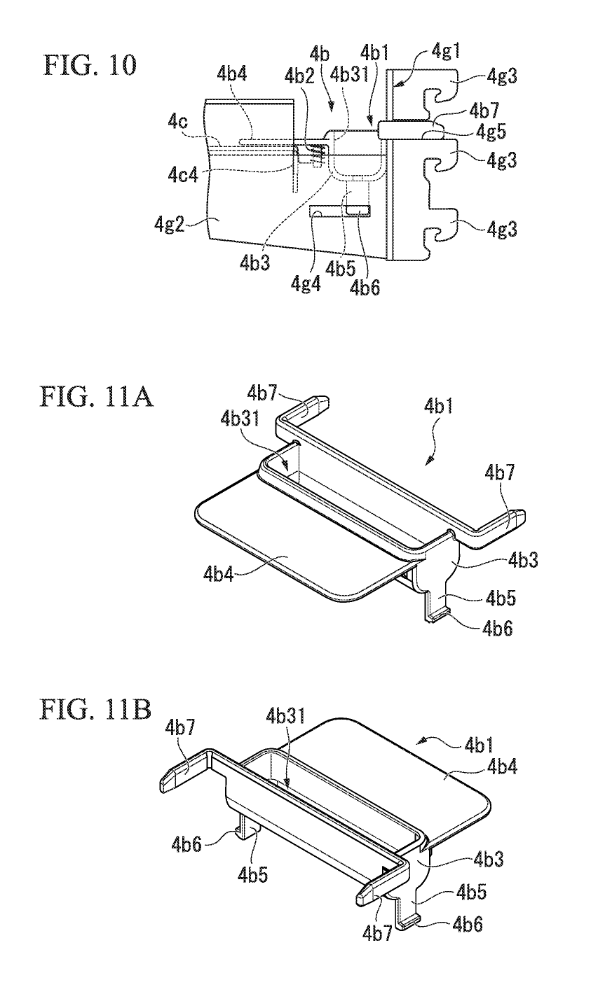

FIG. 7 is a perspective view when the tray support mechanism 4 is viewed from above in a state where the tray 2 is removed. In addition, FIG. 8 is a perspective view when the tray support mechanism 4 is viewed from below in the state where the tray 2 is removed. Moreover, FIG. 9 is a bottom view when the tray support mechanism 4 is viewed from below in a state where the tray 2 is attached. In addition, FIG. 10 is a side view showing a portion of the tray support mechanism 4 on the cart body 3 side in an enlarged manner in the state where the tray 2 is removed. As shown in the drawings, the tray support mechanism 4 includes a support unit 4a and a lock unit 4b.

The support unit 4a includes a third base portion 4c, abutment portions 4d, tray detachment operation portions 4c, the engagement protrusions 4f, and a bracket portion 4g. The third base portion 4c is a plate-shaped portion which directly or indirectly supports the abutment portions 4d, the tray detachment operation portions 4e, and the engagement protrusions 4f. As shown in FIG. 10, the third base portion 4c is formed in an approximately rectangular shape having a smaller area than that of the lower surface of the tray 2, and covers the lower surface of the tray 2 such that the vicinities of both right and left ends of the lower surface of the tray 2 are exposed.

In addition, as shown in FIG. 7, a front edge portion 4c1, a left edge portion 4c2, and a right edge portion 4c3 of the third base portion 4c are bent upward. In addition, a rear edge portion 4c4 of the third base portion 4c is bent downward. The front edge portion 4c1, the left edge portion 4c2, and the right edge portion 4c3 of the third base portion 4c support the abutment portions 4d which are integrally connected to the edge portions 4c 1, 4c2, and 4c3. Moreover, an opening 4c5 into which an operation plate 4c1 described later of the tray detachment operation portion 4e is inserted is formed at the center in the front-rear direction of each of the left edge portion 4c2 and the right edge portion 4c3. Moreover, the rear edge portion 4c4 of the third base portion 4c becomes abutment surface of each of coil springs 4b2 described later of the lock unit 4b.

The abutment portions 4d are integrally provided with the front edge portion 4c1, the left edge portion 4c2, and the right edge portion 4c3 of the third base portion 4c. As shown in FIG. 7, in the present embodiment, as the abutment portions 4d, a front center abutment portion 4d1, a left front abutment portion 4d2, a left rear abutment portion 4d3, a right front abutment portion 4d4, and a right rear abutment portion 4d5 are provided.

The front center abutment portion 4d1 extends rearward from an upper end of the front edge portion 4c1 of the third base portion 4c, and an upper surface of the front center abutment portion 4d1 becomes an abutment surface which abuts the lower surface of the tray 2. The left front abutment portion 4d2 is provided on a front end portion of the left edge portion 4c2 of the third base portion 4c and extends from an upper end of the left edge portion 4c2 toward the right side. An upper surface of the left front abutment portion 4d2 becomes an abutment surface which abuts the lower surface of the tray 2, and the upper surface of the left front abutment portion 4d2 and the upper surface of the front center abutment portion 4d1 are disposed to have the same height as each other. The left rear abutment portion 4d3 is provided on the rear end portion of the left edge portion 4c2 of the third base portion 4c and extends from the upper end of the left edge portion 4c2 toward the right side. An upper surface of the left rear abutment portion 4d3 becomes an abutment surface which abuts the lower surface of the tray 2 and the upper surface of the left rear abutment portion 4d3 and the upper surface of the front center abutment portion 4d1 are disposed to have the same height as each other. The right front abutment portion 4d4 is provided on the front end portion of the right edge portion 4c3 of the third base portion 4c and extends from an upper end of the right edge portion 4c3 toward the left side. An upper surface of the right front abutment portion 4d4 becomes an abutment surface which abuts the lower surface of the tray 2, and the upper surface of the right front abutment portion 4d4 and the upper surface of the front center abutment portion 4d1 are disposed to have the same height as each other. The right rear abutment portion 4d5 is provided on a rear end portion of the right edge portion 4c3 of the third base portion 4c and extends from the upper end of the right edge portion 4c3 toward the left side. An upper surface of the right rear abutment portion 4d5 becomes an abutment surface which abuts the lower surface of the tray 2, the upper surface of the right rear abutment portion 4d5 and the upper surface of the front center abutment portion 4d1 are disposed to have the same height as each other.

All the abutment portions 4d have the abutment surfaces which abut the lower surface of the tray 2 and have the same height as each other. The tray 2 abuts the abutment surfaces to be supported. That is, the tray 2 is supported from below by the upper surface of the front center abutment portion 4d1, the upper surface of left front abutment portion 4d2, the upper surface of the left rear abutment portion 4d3, the upper surface of the right front abutment portion 4d4, and the upper surface of the right rear abutment portion 4d5. Accordingly, a downward movement of the tray 2 is regulated.

In addition, the abutment portions 4d are formed to extend toward the inside of the third base portion 4c from all the upper ends of the front edge portion 4c1, the left edge portion 4c2, and the right edge portion 4c3 which are bent upward as described above. Accordingly, the abutment portions 4d are disposed to be separated from the upper surface of the third base portion 4c by a constant distance. That is, the abutment portions 4d are disposed with a constant gap in the vertical direction between the abutment portions 4d and the upper surface of the third base portion 4c.

For example, in a state where the tray 2 is mounted on the support unit 4a, the extension portion 2c12 of the front protrusion portion 2c1 is inserted below the left front abutment portion 4d2, and the extension portion 2c22 of the rear protrusion portion 2c2 is inserted below the left rear abutment portion 4d3. In addition, the extension portion 2c52 of the front protrusion portion 2c5 is inserted below the right front abutment portion 4d4, and the extension portion 2c62 of the rear protrusion portion 2c6 is inserted below the right rear abutment portion 4d5. Accordingly, if the tray 2 mounted on the support unit 4a tries to move upward, the extension portion 2c12 of the front protrusion portion 2c1 interferes with the left front abutment portion 4d2, the extension portion 2c22 of the rear protrusion portion 2c2 interferes with the left rear abutment portion 4d3, the extension portion 2c52 of the front protrusion portion 2c5 interferes with the right front abutment portion 4d4, and the extension portion 2c62 of the rear protrusion portion 2c6 interferes with the right rear abutment portion 4d5. Accordingly, an upward movement of the tray 2 is regulated.

In addition, for example, if the tray 2 mounted on the support unit 4a tries to move in a right-left direction of the cart device 1, the extension portion 2c12 of the front protrusion portion 2c1 and the extension portion 2c22 of the rear protrusion portion 2c2 interfere with the left edge portion 4c2 of the third base portion 4c. In addition, the extension portion 2c52 of the front protrusion portion 2c5 and the extension portion 2c62 of the rear protrusion portion 2c6 interfere with the right edge portion 4c3 of the third base portion 4c. Accordingly, a movement of the tray 2 in the right-left direction of the cart device 1 is regulated.

The tray detachment operation portion 4e is provided on each of the right side and the left side of the third base portion 4c and is disposed at the center portion of the third base portion 4c in the front-rear direction. Each of the tray detachment operation portions 4e includes the operation plate 4e1 and an urging unit 4e2. Each of the operation plates 4e1 is a plate-shaped member which is disposed to be inserted toward the opening 4c5 which is formed in the third base portion 4c, so as to face its front and rear surfaces an upper-lower direction, and includes a pushing portion 4e3 on the end portion facing the outside of the third base portion 4c. That is, in the operation plate 4e1of the tray detachment operation portion 4e disposed on the left side of the third base portion 4c, the pushing portion 4e3 is provided on the end portion protruding from the opening portion 4c5 toward the left side. In addition, in the operation plate 4e1 of the tray detachment operation portion 4e disposed on the right side of the third base portion 4c, the pushing portion 4e3 is provided on the end portion protruding from the opening portion 4c5 toward the right side.

Each of the urging units 4e2 is fixed to the lower surface of the third base portion 4c and accommodates a portion of the lower portion of the operation plate 4e1. In the urging unit 4e2, a spring (not shown) is installed inside a cover and urges the operation plate 4e1 toward the outside of the third base portion 4c.

In addition, the urging unit 4e2 includes a stopper (not shown) and the stopper defines a movement limit position of the operation plate 4e1 toward the outside of the third base portion 4c.

In a state where an external force except for an urging force from the urging unit. 4c2 is not applied to each of the tray detachment operation portions 4c, each operation plate 4e1is urged to the movement limit position, at which the operation plate 4e1 is regulated by the stopper (not shown), by the urging unit 4e2. Hereinafter, the movement limit position of the operation plate 4e1 is referred to as a reference position. In addition, the reference position of the operation plate 4e1 is set to a position at which the engagement protrusion 4f installed on the operation plate 4e1 is fitted to the fitting gap S1 (or fitting gap S2) of the tray 2 in a state where the tray 2 is mounted on the support unit 4a.

Each of the engagement protrusions 4f is formed on each operation plate 4e1. The operation plate 4e1 is a protrusion having a bar shape which is long in the front-rear direction, and a length thereof in the front-rear direction is set to be slightly shorter than a length of the fitting gap S1 and the fitting gap S2 in the depth direction of the tray 2. The operation plate 4e1 is a reference position, and in a state where the tray 2 is mounted on the support unit 4a, as shown in FIG. 9, each engagement protrusion 4f is fitted to the fitting gap S1 (or fitting gap S2) of the tray 2.

For example, if the engagement protrusion 4f is fitted to the fitting gap S1 of the tray 2, as shown in FIG. 9, the front center protrusion portion 2c3 and the rear center protrusion portion 2c4 of the tray 2 are disposed in front of and behind the engagement protrusion 4f. As a result, when the tray 2 moves in the front-rear direction of the cart device 1, the engagement protrusion 4f interferes with the front center protrusion portion 2c3 or the rear center protrusion portion 2c4, and the movement of the tray 2 in the front-rear direction is regulated. In addition, if the engagement protrusion 4f is fitted to the fitting gap S2, as shown in FIG. 9, the front center protrusion portion 2c7 and the rear center protrusion portion 2c8 of the tray 2 are disposed in front of and behind the engagement protrusion 4f. As a result, when the tray 2 moves in the front-rear direction of the cart device 1, the engagement protrusion 4f interferes with the front center protrusion portion 2c7 or the rear center protrusion portion 2c8, the movement of the tray 2 in the front-rear direction is regulated. Accordingly, the tray 2 mounted on the support unit 4a cannot move in the front-rear direction of the cart device 1.

In the bracket portion 4g, as shown in FIG. 8 or 10, the bracket portion 4g includes a fourth base portion 4g1 (attachment portion) which is fixed to the support base 3b of the cart body 3 and two arms 4g2 which extend forward from the fourth base portion 4g1. The fourth base portion 4g1 is a portion which is formed in an approximately U shape when viewed in the vertical direction, and as shown in FIG. 10, includes locking claws 4g3 which are formed on each of approximately U shaped-portions. In the present embodiment, three locking claws 4g3 are vertically arranged on each of two end portions having an approximately U shape. The vertical arrangement pitch of the locking claws 4g3 is the same as a vertical arrangement pitch of the locking holes 3b6 of the shelf posts 3b4 of the cart body 3, and the locking claws 4g3 can be inserted into the locking holes 3b6. In addition, the locking claws 4g3 inserted into the locking holes 3b6 are moved downward, and thus, are locked to the shelf posts 3b4. Accordingly, the bracket portion 4g (that is, the tray support mechanism 4) is fixed to the cart body 3. In addition, by lifting the bracket portion 4g (that is, the tray support mechanism 4) fixed to the cart body 3 with respect to the cart body 3, the locking claws 4g3 are separated from the shelf posts 3b4, and thus, the bracket portion 4g can be removed from the cart body 3.

In addition, as described above, the plurality of locking holes 3b6 arc vertically formed in the shelf posts 3b4. Accordingly, in the bracket portion 4g (that is, the tray support mechanism 4), the fourth base portion 4g1 can be fixed at an arbitrary position in the height direction of the support base 3b. That is, in the present embodiment, the tray support mechanism 4 can be attached to arbitrary positions of the shelf posts 3b4 (attached portion) which are provided in a certain range of the support base 3b which is a portion of the cart body 3.

In addition, in the fourth base portion 4g1, a second slit 4g5 is formed between the locking claw 4g3 disposed on the uppermost side and the locking claw 4g3 disposed at the center in the vertical direction among the three locking claws 4g3 arranged in the vertical direction. This second slit 4g5 is a region into which a wedge portion 4b7 of a lock member 4b1 described later of the lock unit 4b is movably inserted in the front-rear direction of the cart device 1.

As shown in FIG. 8, the arms 4g2 are disposed to be separated from each other in the right-left direction of the cart device 1, and root portions of the arms 4g2 are fixed to the fourth base portion 4g1. Each of the arms 4g2 is formed in a plate shape thinned in the right-left direction of the cart device 1, and upper ends of the arms 4g2 are fixed to the lower surface of the third base portion 4c. The arms 4g2 support the fourth base portion 4g1 from below. In addition, as shown in FIG. 8, a first slit 4g4 extending in the front-rear direction is formed in the vicinity of each of the roots of the arms 4g2. Claw portions 4b6 of the lock member 4b1 described later of the lock unit 45 are inserted into the first slits 4g4. In addition, each of the first slits 4g4 is set such that a width of the first slit 4g4 in the front-rear direction of the cart device 1 is longer than that of the claw portion 4b6. Accordingly, in a state where the claw portions 4b6 are inserted into the first slits 4g4, the claw portions 4b6 can move in the front-rear direction of the cart device 1.

As shown in FIG. 10, the lock unit 4b includes the lock member 4b1 and the coil springs 4b2. FIGS. 11A and 11B are perspective views of the lock member 4b1, FIG. 11A is a perspective view when the lock member 4b1 is viewed from the front side of the cart device 1, and FIG. 11B is a perspective view when the lock member 4b1 is viewed from the rear side of the cart device 1.

As shown in the drawings, the lock member 4b1 includes a second base portion 4b3 in which a second groove portion 4b31 to which a worker's fingers are hooked is formed, an extension plate 4b4 which extends from the second base portion 4b3 to the front side of the cart device 1, second hanging portions 4b5 which are hanged downward from the second base portion 4b3, the claw portions 4b6 which protrude to the outside from lower ends of the second hanging portions 4b5, and the wedge portions 4b7 which are provided to protrude rearward from the second base portion 4b3.

The second base portion 4b3 is formed to be long in the right-left direction and is disposed between the arms 4g2 of the bracket portion 4g (refer to FIG. 8). In addition, the second base portion 4b3 is disposed to be movable in the front-rear direction between the third base portion 4c of the support unit 4a and the fourth base portion 4g1 of the bracket portion 4g. The above-described second groove portion 4b31 is formed along the direction in which the second base portion 4b3 extends. The extension plate 4b4 is disposed to be parallel to an upper surface of the third base portion 4c above the upper surface of the third base portion 4c of the support unit 4a. The worker hooks his/her fingers to the second groove portion 4b31 and pulls the lock member 4b1, and thus, the extension plate 4b4 moves along the upper surface of the third base portion 4c of the support unit 4a.

The second hanging portions 4b5 are each installed on both end portions of the second base portion 4b3 in the right-left direction. The claw portions 4b6 are inserted into the first slits 4g4 formed in the arms 4g2 of the bracket portion 4g.

The claw portions 4b6 formed in the two second hanging portions 4b5 arc inserted into the first slits 4g4, and thus, the movements of the lock member 4b1 in the right-left direction and the vertical direction with respect to the bracket portion 4g are regulated. That is, the claw portions 4b6 are inserted into the first slits 4g4, and thus, the lock member 4b1 can move in only the front-rear direction within a range of the length of the first slit 4g4 in the front-rear direction.

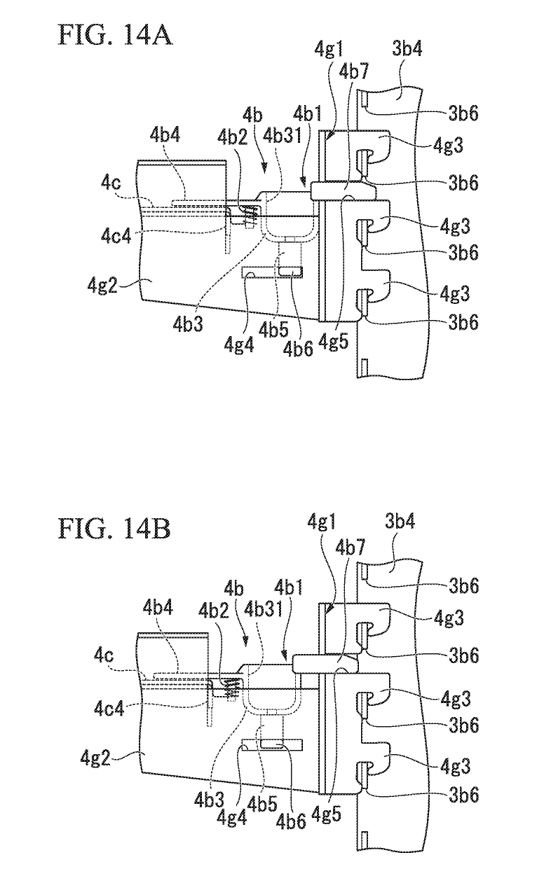

The wedge portions 4b7 are respectively installed on both end portions of the second base portion 4b3 in the right-left direction. As shown in FIG. 10, the wedge portions 4b7 are disposed in the second slit 4g5 formed in the fourth base portion 4g1 of the bracket portion 4g. The lock member 4b1 is moved in the front-rear direction, and thus, the wedge portions 4b7 are moved in the front-rear direction along the second slits 4g5. In addition, the length of each of the wedge portions 4b7 in the front-rear direction is set such that a tip portion of the wedge portion 4b7 is disposed between the locking claws 4g3 of the bracket portion 4g when viewed in the vertical direction in a case where the lock member 4b1 is moved most backward and the tip portion is drawn from a portion between the locking claws 4g3 of the bracket portion 4g when viewed in the vertical direction in a case where the lock member 4b1 moves most forward. In addition, the thickness of each of the wedge portions 4b7 in the vertical direction is set such that in a state where the locking claw 4g3 of the bracket portion 4g is locked to the shelf post 3b4, the wedge portion 4b7 can be inserted into a gap formed above the locking claw 4g3 and is embedded in the locking hole 3b6 together with the locking claw 4g3. If the wedge portion 4b7 can be inserted into the gap formed above the locking claw 4g3 and is embedded in the locking hole 3b6 together with the locking claw 4g3, the locking claw 4g3 cannot move upward, and thus, the support unit 4a (that is, the tray support mechanism 4) cannot be detached from the cart body 3 (refer to FIG. 14A). That is, the tray support mechanism 4 is locked to the cart body 3.

Each of the coil springs 4b2 is wound around a protrusion which is formed on the lower surface of the extension plate 4b4, and a tip portion of the coil spring 4b2 abuts the rear edge portion 4c4 of the third base portion 4c of the support unit 4a. As shown in FIG. 9, three coil springs 4b2 are arranged in the right-left direction. The coil springs 4b2 urge the lock member 4b1 to the rear side (the side of the support base 3b side of the cart body 3). Accordingly, in the state where an external force except for the urging forces of the coil springs 4b2 is not applied to the lock member 4b1, the lock member 4b1 is urged to the rear side (that is, the side of the support base 3b of the cart body 3). Accordingly, in a case where the worker has not moved the lock member 4b1 forward, the above-described wedge portions 4b7 can be inserted into the gap formed above the locking claws 4g3, and thus, the tray support mechanism 4 is locked to the cart body 3.

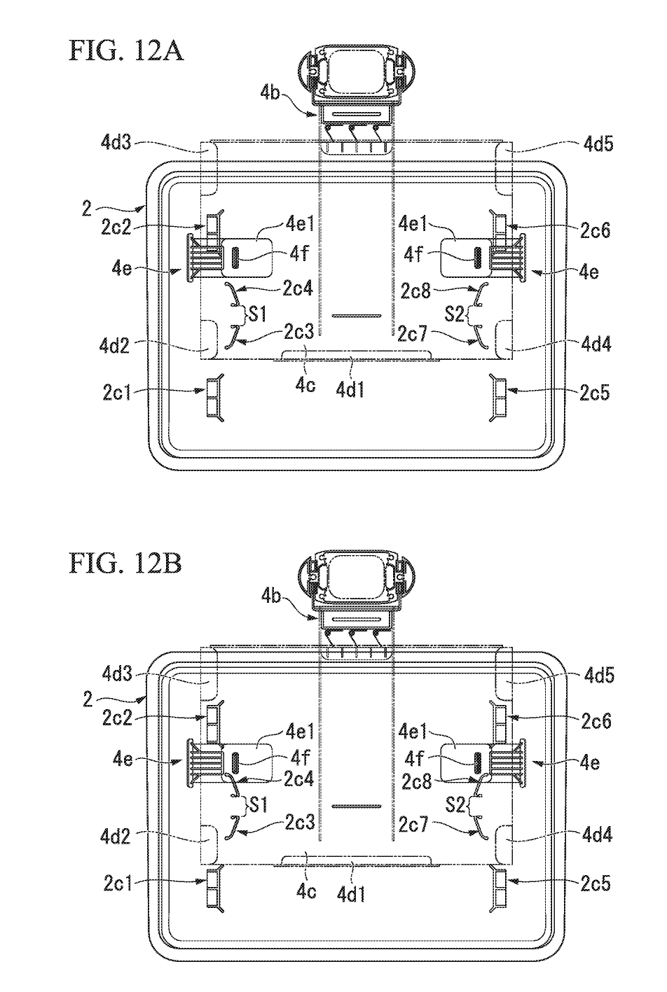

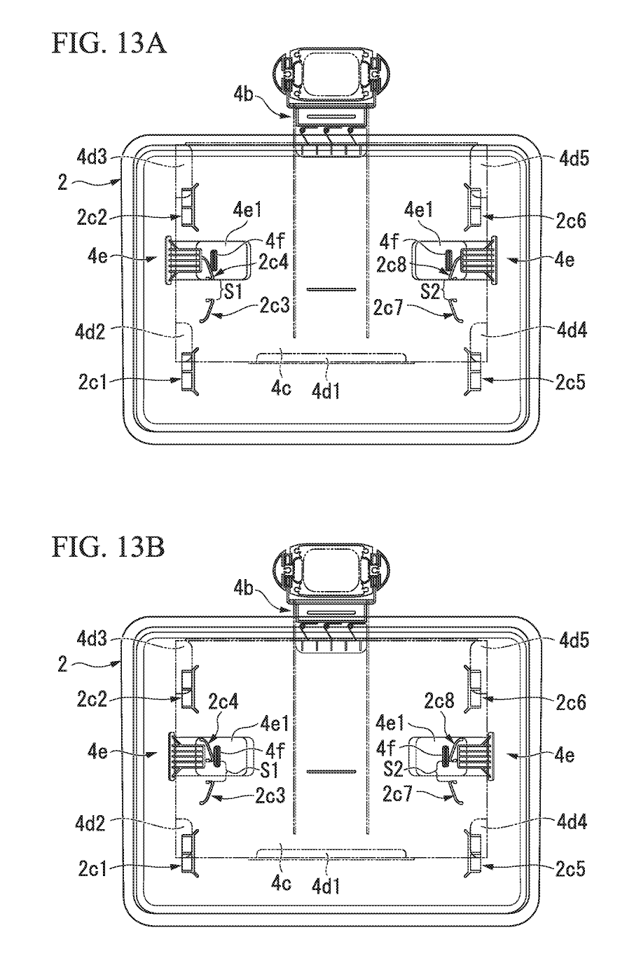

Subsequently, in the cart device 1 of the present embodiment configured as described above, an operation when the tray 2 is mounted on the tray support mechanism 4 will he described with reference to FIGS. 12A, 12B, 13A, and 13B.

First, as shown in FIG. 12A, the tray 2 is disposed on the front side toward the mounting position (fixed position) of the tray support mechanism 4. In this case, the tray 2 is disposed such that the front protrusion portion 2c1, the rear protrusion portion 2c2, the front center protrusion portion 2c3, the rear center protrusion portion 2c4, the front protrusion portion 2c5, the rear protrusion portion 2c6, the front center protrusion portion 2c7, and the rear center protrusion portion 2c8 of the tray 2 do not interfere with the front center abutment portion 4d1, the left front abutment portion 4d2, the left rear abutment portion 4d3, the right front abutment portion 4d4, and the right rear abutment portion 4d5 provided in the third base portion 4c of the support unit 4a.

Subsequently, as shown in FIG. 12B, the tray 2 slides rearward. In addition, as shown in FIGS. 13A and 13B, if the engagement protrusion 41 installed on the operation plate 4e1 comes into contact with the rear center protrusion portion 2c4 included in the left protrusion group 2cA (refer to FIG. 4A) or the rear center protrusion portion 2c8 included in the right protrusion group 2cB (refer to FIG. 4A), the engagement protrusion 4f is guided along the inclined surface 2c41 (refer to FIG. 4A) of the rear center protrusion portion 2c4 or the inclined surface 2c81 (refer to FIG. 4A) of the rear center protrusion portion 2c8 to be gradually moved to the center side of the tray support mechanism 4.

In addition, when the engagement protrusion 4f reaches the fitting gap S1 or the fitting gap S2, the engagement protrusion 4f is fitted to the fitting gap S1 or the fitting gap S2 by the urging force of the urging unit 4e2 of the tray detachment operation portion 4c (refer to FIG. 9). In this way, if the engagement protrusion 4f is fitted to the fitting gap S1 or the fitting gap S2, the front protrusion portion 2c1 of the tray 2 and the left front abutment portion 4d2 of the support unit 4a are disposed to overlap each other in the vertical direction, the rear protrusion portion 2c2 of the tray 2 and the left rear abutment portion 4d3 of the support unit 4a are disposed to overlap each other in the vertical direction, the front protrusion portion 2c5 of the tray 2 and the right front abutment portion 4d4 of the support unit 4a arc disposed to overlap each other in the vertical direction, and the rear protrusion portion 2c6 of the tray 2 and the right rear abutment portion 4d5 of the support unit 4a are disposed to overlap each other in the vertical direction. As a result of the above, the tray 2 is fixed to the tray support mechanism 4 forward, backward, right, left, up, and down, and the mounting of the tray 2 is completed.

In addition, in a case where the tray 2 mounted as described above is detached from the tray support mechanism 4, the operation plate 4e1 of the tray detachment operation portion 4e is moved by pressing the pushing portion 4e3. Accordingly, the engagement protrusion 4f moves backward from the fitting gap S1 or the fitting gap S2, and thus, the tray 2 can be moved in the front-rear direction. In this state, the worker moves the tray 2 to the position shown in FIG. 12A and thereafter, lifts the tray 2 by gripping the tray 2, and thus, the tray 2 is detached from the tray support mechanism 4.

Moreover, here, the example in which the tray 2 is mounted on the tray support mechanism 4 in a state where the rear side of the tray 2 faces the support base 3b side of the cart body 3 is described. That is, the example in which the tray 2 is mounted as shown in FIGS. 2A and 213 is described. However, in the cart device 1 of the present embodiment, as shown in FIGS. 1A and 1B, the tray 2 in the state where the front side of the tray 2 faces the support base 3b side of the cart body 3 can be mounted on the tray support mechanism 4.

In this case, if the tray 2 is mounted, the engagement protrusion 4f installed on the operation plate 4e1 comes into contact with the front center protrusion portion 2c3 included in the left protrusion group 2cA (refer to FIG. 4A) or the front center protrusion portion 2c7 included in the right protrusion group 2cB (refer to FIG. 4A). Accordingly, the engagement protrusion 4f is guided along the inclined surface 2c31 (refer to FIG. 4A) of the front center protrusion portion 2c3 or the inclined surface 2c71 (refer to FIG. 4A) of the front center protrusion portion 2c7 to be gradually moved to the center side of the tray support mechanism 4.

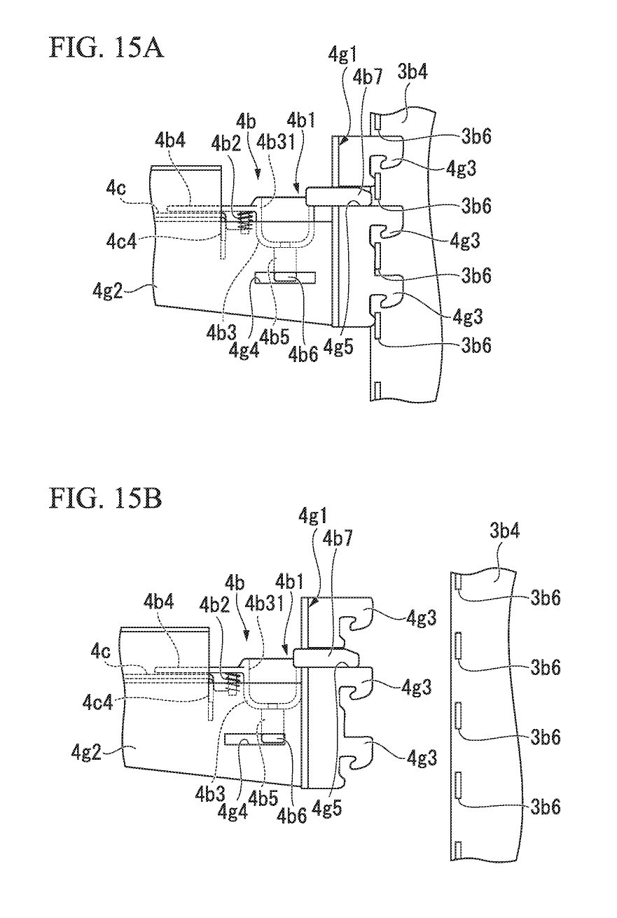

Subsequently, in the cart device 1 of the present embodiment, an operation when the tray support mechanism 4 is detached from the cart body 3 will he described with reference to FIGS. 14A, 14B, 15A, and 15B.

As shown in FIG. 14A, in the state where the external force except for the urging forces of the coil springs 4b2 is not applied to the lock member 4b1, the lock member 4b1 is urged to the rear side (that is, the support base 3b side of the cart body 3), and thus, the wedge portions 4b7 can be inserted into the gaps formed above the locking claws 4g3. Accordingly, the tray support mechanism 4 is locked to the cart body 3, and thus, the tray support mechanism 4 cannot be lifted.

Accordingly, first, as shown in FIG. 14B, the lock member 4b1 is pulled to the front side. This work is performed in a state where the worker's fingers are hooked to the second groove portion 4b31. Accordingly, the wedge portions 4b7 are removed from the locking holes 3b6, and thus, it is possible to lift the tray support mechanism 4. Thereafter, as shown in FIG. 15A, the tray support mechanism 4 is lifted, and as shown in FIG. 15B, the tray support mechanism 4 is extracted such that the locking claws 4g3 are removed from the locking holes 3b6, and thus, it is possible to detach the tray support mechanism 4 from the cart body 3.

In addition, when the tray support mechanism 4 is mounted on the cart body 3, the external force except for the urging forces of the coil springs 4b2 is not applied to the lock member 4b1, and thus, the lock member 4b1 is urged most backward. Accordingly, when the locking claws 4g3 are inserted into the locking holes 3b6, the wedge portions 4b7 interfere with the shelf posts 3b4. Meanwhile, by further pushing the tray support mechanism 4, a reaction force received by the lock member 4b1 from the shelf posts 3b4 exceeds the urging forces of the coil springs 4b2, and thus, particularly, it is possible to mount the tray support mechanism 4 on the cart body 3 without operating the lock member 4b1.

Hereinbefore, in the tray 2 and the cart device 1 of the above-described present embodiment, the orientation of the tray 2 with respect to the tray support mechanism 4 is changed and the tray 2 is detachably attached to the tray support mechanism 4. Moreover, in the tray 2 and the cart device 1 of the present embodiment, the orientation of the tray 2 with respect to the cart body 3 is changed and the tray 2 is detachably attached to the cart body 3, and the aspect of the article accommodation region of the tray 2 when the tray 2 is mounted on the tray support mechanism 4 (that is, when the article placing area is mounted on the fixture body in a first orientation) such that the front side faces the support base 3b side and the aspect of the article accommodation region of the tray 2 when the tray 2 is mounted on the tray support mechanism 4 (that is, when the article placing area is mounted on the fixture body in a second orientation different from the first orientation) such that the rear side faces the support base 3b side are different from each other. That is, when the tray 2 is mounted on the tray support mechanism 4 such that the front side faces the support base 3b side, the article accommodation region becomes the aspect in which the front accommodation region Ra is disposed on the rear side of the cart device 1 and the rear accommodation region Rb is disposed on the front side of the cart device 1. Meanwhile, when the tray 2 is mounted on the tray support mechanism 4 such that the rear side faces the support base 3b side, the article accommodation region becomes the aspect in which the front accommodation region Ra is disposed on the front side of the cart device 1 and the rear accommodation region Rb is disposed on the rear side of the cart device 1.

Moreover, as shown in FIGS. 1A and 1B or FIGS. 2A and 2B, in the cart device 1 of the present embodiment, the tray 2 in which the front side is disposed to face the support base 3b side and the tray 2 in which the rear side is disposed to face the support base 3b side are provided. Accordingly, the aspects of the article accommodation regions of the two trays 2 are different from each other, and thus, even when the article is delivered to tray 2 in the same direction, it is possible to select the tray 2 in which the aspect of the article accommodation region is suitable for article delivery. For example, in the tray 2, the peripheral wall portion 2b on the front side is low, and thus, the article is easily put in the tray 2 or taken out from the tray 2 from the front side. Accordingly, in a case where the worker who operates the cart device 1 mainly performs putting-in or taking-out of the article, the worker puts the article in the tray 2 of which the front surface faces the rear side of the cart device 1 or takes out the article from the tray 2. Meanwhile, in a case where a person in front of the cart device 1 mainly performs the putting-in or taking-out of the article, the person puts the article in the tray 2 of which the front surface faces the front side of the cart device 1 or takes out the article from the tray 2. According to the cart device 1 of the present embodiment., it is possible to further improve usability.

Therefore, according to the tray 2 and the cart device 1 of the present embodiment, even when the article is taken out from the tray 2 in the same direction, workability when the article is taken out is changed according to the orientation of the tray 2. Accordingly, according to the tray 2 and the cart device 1 of the present embodiment, it is possible to flexibly change the use aspect of one tray 2 according to situations.

In addition, according to the tray 2 and the cart device 1 of the present embodiment, the use aspect of one tray 2 can be changed, and thus, it is not necessary to prepare the article placing areas having a plurality of shapes, and it is possible to suppress an amount of capital investment by decreasing the number of the molding dies or the like or it is possible to decrease the number of management steps or management cost.

Moreover, the cart device 1 of the present embodiment includes the tray support mechanism 4 which detachably supports the tray 2 and the support base 3b which supports the tray support mechanism 4 and includes front and rear shelf posts 3b4 to which tray support mechanism 4 is attached. Accordingly, the tray support mechanism 4, that is, the tray 2 can be disposed in front of and behind the support base 3b.

Moreover, the cart device 1 of the present embodiment, the shelf post 3b4 extends in the vertical direction, and the tray support mechanism 4 includes the fourth base portion 4g1 which can be fixed to the shelf post 3b4 at an arbitrary position of the shelf post 3b4 in the vertical direction. Accordingly, it is possible to arbitrarily change the fixed position of the tray support mechanism 4 with respect to the support base 3b in the vertical direction.

Moreover, in the cart device 1 of the present embodiment, the bottom plate 2a having the upper surface which becomes the placing surface of the article, the front wall 2d which uprightly stands on the front edge portion of the bottom plate 2a, and the rear wall 2e which uprightly stands on the rear edge portion of the bottom plate 2a and has a height higher than the front wall 2d from the bottom plate 2a. According to the tray 2 and the cart device 1 of the present embodiment, by changing the heights of the front wall 2d and the rear wall 2e, the two regions (front accommodation region and rear accommodation region) having different depths are formed. Accordingly, a small article and a large article can be simultaneously accommodated stably. Moreover, the bottom plate 2a can be flattened, and thus, it is possible to stably accommodate the article.

In addition, in the cart device 1 of the present embodiment, the front wall 2d and the rear wall 2e are configured of a portion of the peripheral wall portion 2b which uprightly stands along the edge portion of the bottom plate 2a. In addition, the first side wall 2f includes the front portion 2f1 which is a portion which is connected to the front wall 2d and has the same height as the height of the front wall 2d. Moreover, the first side wall 2f includes the rear portion 2f2 which is a portion which is connected to the rear wall 2e and has the same height as the height of the rear wall 2e. In addition, the second side wall 2g includes the front portion 2g1 which is a portion which is connected to the front wall 2d and has the same height as the height of the front wall 2d. Moreover, the second side wall 2g includes the rear portion 2g2 which is a portion which is connected to the rear wall 2e and has the same height as the height of the rear wall 2e. Accordingly, in the vicinities of the front wall 2d and the rear wall 2e, it is possible to prevent the article from falling from the entire peripheral wall portion 2b without protruding the first side wall 2f and the second side wall 2g upward from the front wall 2d and the rear wall 2e and damaging workability of putting the article in the article accommodation region or taking the article out therefrom. Accordingly, it is possible to accommodate the article more stably.

Hereinbefore, a preferred embodiment of the present invention is described with reference to the accompanying drawings. However, the present invention is not limited to the above embodiment. Various shapes and combinations of the constituent members shown in the above-described embodiment are merely examples, and various modifications can be made based on design requirements or the like within a scope which does not depart from the gist of the present invention.

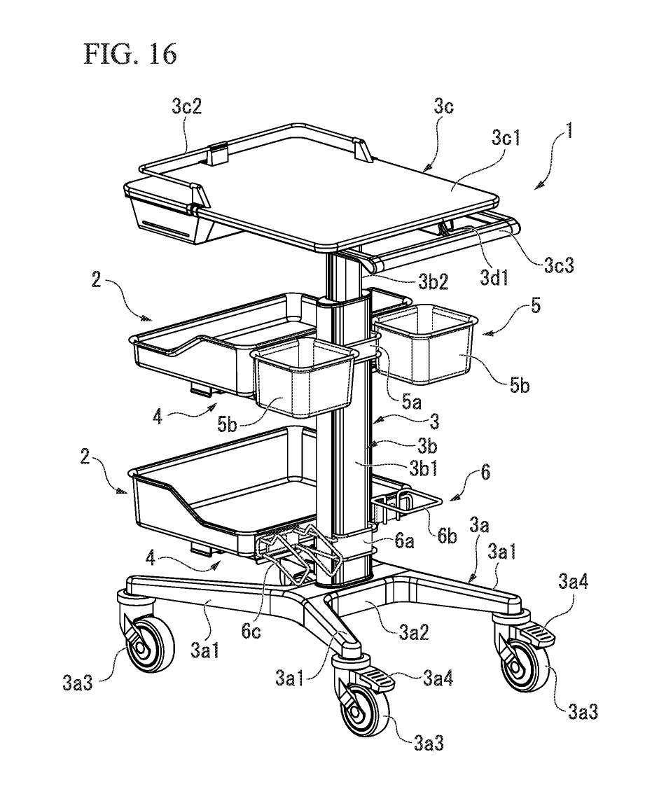

For example, in the embodiment, the configuration in which the trays 2 are installed in only front of the support base 3b is described. However, as shown in FIG. 16, the present invention is not limited to this. FIG. 16 a perspective view showing a modification example of the cart device which includes a tray unit 5 (article placing area) and a hanger unit 6 (article placing area) installed behind the support base 3b. In the present modification example, each of the trays 2 corresponds to a front article placing area of the present invention and each of the tray unit 5 and the hanger unit 6 corresponds to a rear placing area.

The tray unit 5 includes a fixing portion 5a which is fixed at a vertically arbitrary position of the shelf post 3b4 (refer to FIGS. 6A and 6B) disposed on the rear side of the support base 3b and small trays 5b installed on both right and left sides of the fixing portion 5a. The fixing portion 5a of the tray unit 5 includes a locking claw (not shown), the locking claw is inserted into an arbitrary locking hole 3b6 of the shelf post 3b4, the shelf posts 3b4 can be locked, and thus, it is possible to fix the fixing portion 5a at an arbitrary position in the vertical direction. In a case where the fixing portion 5a is disposed at a predetermined height, heights of the small trays 5b are set such that the upper end portion (the upper end portion of the rear wall portion 2e in FIG. 16) of the tray 2 on the support base 3b side and the upper end portions of the small trays 5b have the same height as each other. In this way, the upper end portion of the tray 2 on the support base 3b side and the upper end portions of the small trays 5b of the tray unit 5 have the same height as each other, and thus, it is possible to easily deliver the article between the tray 2 and the small trays 5b.

In addition, even in a case where the tray 2 is disposed such that the front side thereof faces the support base 3b side, preferably, the upper end (that is, the upper end portion of the front wall 2d) of the tray 2 on the support base 3b side and the upper end portions of the small trays 5b have the same height as each other. Accordingly, preferably, a height difference between the front wall 2d and the rear wall 2e of the tray 2 is an integral multiple of the pitch of the locking holes 3b6 of the shelf post 3b4.

The hanger unit 6 includes a fixing portion 6a which is fixed at a vertically arbitrary position of the shelf post 3b4 (refer to FIGS. 6A and 6B) disposed on the rear side of the support base 3b and hanger portions 6b installed on both right and left sides of the fixing portion 6a. Each of the hanger portions 6b can hang and support a baglike article. The hanger unit 6 is installed, and thus, it is possible to support the article by hanging the article.

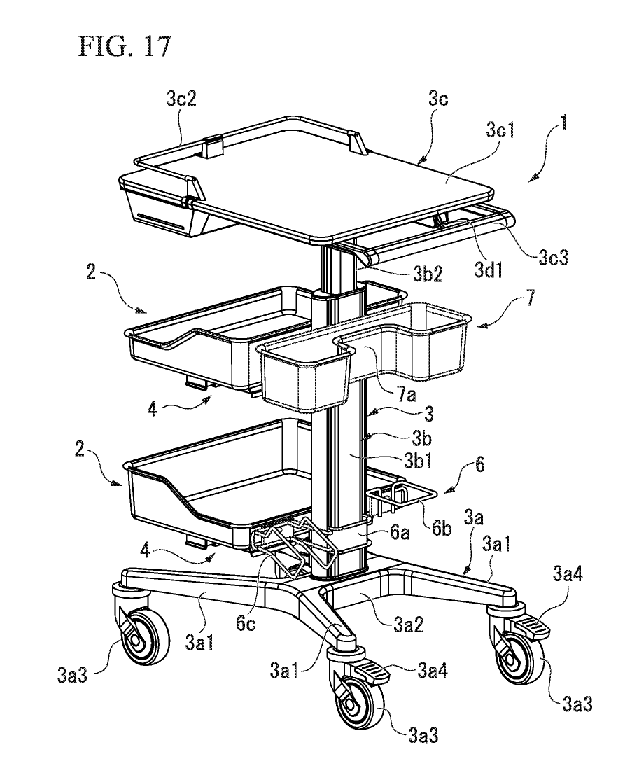

In addition, the shape of the tray in a plan view does not need to be rectangular. For example, as shown in FIG. 17, it is possible to install the tray 7 having an approximately U shape in a plan view. In addition, by disposing the tray 7 such that the front side and the rear side of the approximately U-shaped tray 7 are inverted, the tray 7 can surround the support base 3b from three sides.

Moreover, in the embodiment, the configuration is described, which has the peripheral wall portions 2b in which the heights of the front side and the rear side of the tray 2 are different from each other. However, the present invention is not limited to this, for example, the heights of the peripheral wall portion 2b on the front side and the rear side of the tray 2 can be the same as each other, and the fall prevention bar or the like can be installed to the peripheral wall portion 2b.

In addition, in the tray 2 and the cart device 1 of the present embodiment, the depth of the front accommodation region Ra which is the front region of the article accommodation region and the depth of the rear accommodation region Rb which is the rear region of the article accommodation region are different from each other. In this way, the two regions (front accommodation region and rear accommodation region) having the depths different from each other are provided, and thus, it is possible to simultaneously accommodate a small article and a large article stably.

In addition, the tray 2 and the cart device 1 of the present embodiment, the bottom plate 2a having the upper surface which becomes the placing surface of the article, the front wall 2d which uprightly stands on the front edge portion of the bottom plate 2a, and the rear wall 2e which uprightly stands on the rear edge portion of the bottom plate 2a and has a height higher than the front wall 2d from the bottom plate 2a are provided. According to the tray 2 and the cart device 1 of the present embodiment, the two regions (front accommodation region and rear accommodation region) having the depths different from each other are formed by changing the heights of the front wall 2d and the rear wall 2e. Accordingly, the bottom plate 2a can be flattened, and thus, it is possible to stably accommodate the article.

Moreover, in the tray 2 and the cart device 1 of the present embodiment, the front wall 2d and the rear wall 2e are configured of a portion of the peripheral wall portion 2b which uprightly stands along the edge portion of the bottom plate 2a. In addition, in the tray 2 and the cart device 1 of the present embodiment, the peripheral wall portion 2b uprightly stands along the edge portion of the bottom plate 2a, and thus, it is possible to prevent the article from falling from the entire region around the bottom plate 2a. Accordingly, it is possible to stably accommodate the article.

In addition, in the tray 2 and the cart device 1 of the present embodiment, the flange 2b1 is formed on the upper end of the peripheral wall portion 2b. Therefore, according to the present invention, the flange 2b1 is provided on the upper end of the peripheral wall portion 2b. Accordingly, compared to a case where the flange 2b1 is not provided and the upper end of the peripheral wall portion 2b is thin, it is possible to soften a feeling of a worker when the worker's fingers come into contact with the upper end of the peripheral wall portion 2b to put the article in the tray or take out the article from the tray. Moreover, in the tray 2 and the cart device 1 of the present embodiment, it is possible to improve strength of the tray 2 by the flange 2b1.

Hereinbefore, a preferred embodiment of the present invention is described with reference to the accompanying drawings. However, the present invention is not limited to the above embodiment. Various shapes and combinations of the constituent members shown in the above-described embodiment are merely examples, and various modifications can be made based on design requirements or the like within a scope which does not depart from the gist of the present invention.

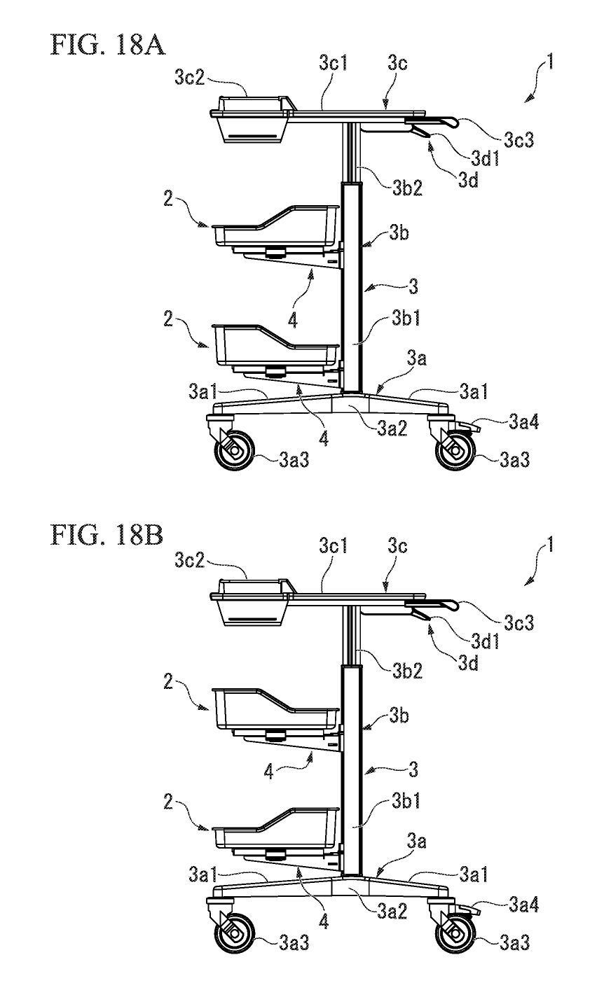

For example, FIGS. 18A and 18B are side views showing a modification example in which orientations of the two trays 2 included in the cart device 1 are different from each other. As shown in FIG. 18A, in the two trays 2, the upper tray 2 may be mounted such that the rear side faces the cart body 3 side and the lower tray 2 may be mounted such that the front side faces the cart body 3 side. Moreover, as shown in FIG. 18B, in the two trays 2, the lower tray 2 may he mounted such that the rear side faces the cart body 3 side and the upper tray 2 may be mounted such that the front side faces the cart body 3 side.

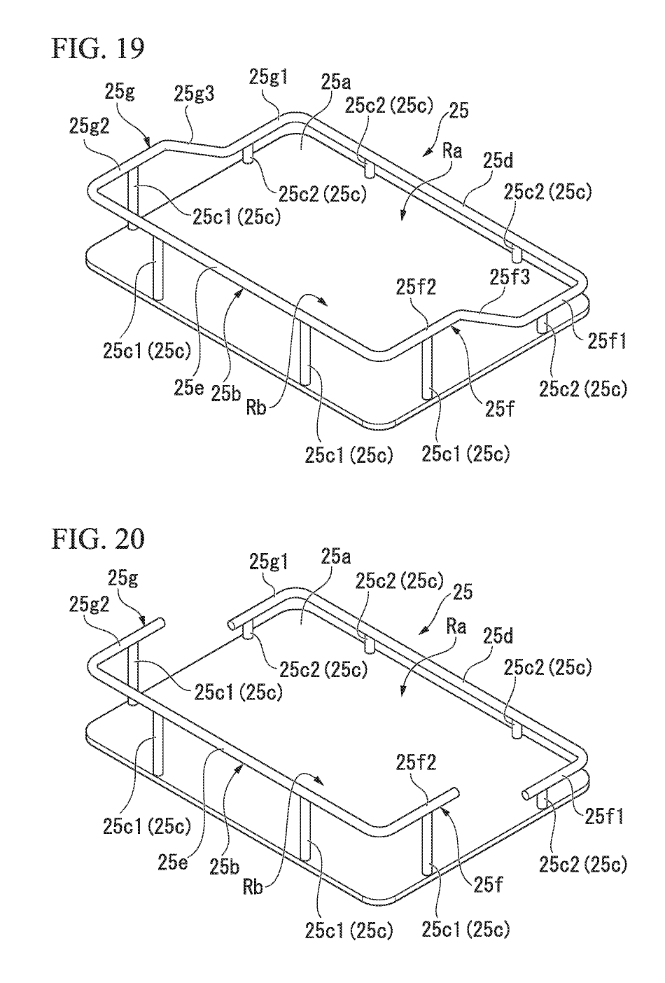

Moreover, in the embodiment, the configuration is described in which the front fall prevention portion is configured of the front wall 2d which is a portion of the peripheral wall portion 2b and the rear fall prevention portion is the rear wall 2e which is a portion of the peripheral wall portion 2b. However, the present invention is not limited to this. For example, as shown in FIG. 19, a tray 25 can be provided, in which the front fall prevention portion and the rear fall prevention portion arc formed by one portion of a fence portion 25b.

The tray 25 includes a bottom plate 25a and the fence portion 25b which uprightly stands on an edge portion of the bottom plate 25a.

In addition, similarly to the embodiment, the protrusion portions are formed on a lower surface of the tray 25. The fence portion 25b includes support pillars 25c, a front bar 25d (front fall prevention portion) which is disposed above a front long side of the bottom plate 25a, a rear bar 25e (rear fall prevention portion) which is disposed above a rear long side of the bottom plate 25a, a first side bar 25f which is disposed above a left side of the bottom plate 25a, and a second side bar 25g which is disposed above a right side of the bottom plate 25a.

The front bar 25d is disposed at a position (that is, is disposed to be lower than the rear bar 25e) than that of the rear bar 25e. That is, the rear bar 25e is disposed at a position (that is, is disposed to be higher than the rear bar 25e) than that of the front bar 25d. In addition, the first side bar 25f is connected to a left end of the front bar 25d and a left end of the rear bar 25e. Moreover, the second side bar 25g is connected to a right end of the front bar 25d and a right end of the rear bar 25e.

The first side bar 25f includes a front-side bar 25f1, a rear-side bar 25f2, and an intermediate bar 25f3. The front-side bar 25f1 is a portion which is connected to the front bar 25d and has the same height as that of the front bar 25d. The rear-side bar 25f2 is a portion which is connected to the rear bar 25e and has the same height as that of the rear bar 25e. The intermediate bar 25f3 is a portion which is disposed between the front-side bar 25f1 and the rear-side bar 25f2 and has an upper end which is inclined to be linearly connected to an upper end of the front-side bar 25f1 and an upper end of the rear-side bar 25f2.

The second side bar 25g includes a front-side bar 25g1, a rear-side bar 25g2, and an intermediate bar 25g3. The front-side bar 25g1 is a portion which is connected to the front bar 25d and has the same height as that of the front bar 25d. The rear-side bar 25g2 is a portion which is connected to the rear bar 25e and has the same height as that of the rear bar 25e. The intermediate bar 25g3 is a portion which is disposed between the front-side bar 25g1 and the rear-side bar 25g2 and has an upper end which is inclined to be linearly connected to an upper end of the front-side bar 25g1 and an upper end of the rear-side bar 25g2. In addition, as shown in FIG. 19, the intermediate bar 25f3 of the first side bar 25f and the intermediate bar 25g3 o the second side bar 25g are provided at the same location as each other in the depth direction.

Moreover, the tray 25 includes first support pillars 25c1 which support the rear bar 25e, the rear-side bar 25f2, and the rear-side bar 25g2, as the support pillars 25c. In addition, tray 25 includes second support pillars 25c2 which support the front bar 25d, the front-side bar 25f1, and the front-side bar 25g1, as the support pillars 25c. The length of each of the first support pillars 25c1 is set to be longer than that of each of the second support pillars 25c2.

In the tray 25 having the fence portion 25b, a region surrounded by the fence portion 25b becomes a region (article accommodation region) which can accommodate the article. In addition, as shown in FIG. 19, in the tray 25, the height of the front bar 25d disposed on the front side is low, and the height of the rear bar 25e disposed on the rear side is high. Accordingly, the fence portion 25b is low in the front accommodation region Ra which is a portion of the front side of the article accommodation region of the tray 25, and thus, the article is easily put in the front accommodation region Ra or taken out therefrom, and the front accommodation region Ra becomes a region suitable for accommodating a small article. Meanwhile, the fence portion 25b is high in the rear accommodation region Ra which is a portion of the rear side of the accommodation region of the tray 25, and thus, even when a tall article is inclined by traveling vibrations or the like of the cart device 1, the tall article can be supported, and for example, the rear accommodation region Rb becomes a region suitable for accommodating a tall article stably.

Similarly to the tray 2 of the embodiment, in a case where the tray 25 is viewed from the front side, the front accommodation region Ra with a shallow depth is positioned on the front side and the rear accommodation region Rb with a deep depth is disposed on the rear side. Meanwhile, in a case where the tray 25 is viewed from the rear side, the rear accommodation region Rb with a deep depth is disposed on the front side and the front accommodation region Ra with a shallow depth is disposed on the rear side. That is, in the tray 25 of the present embodiment, by reversing an orientation of the tray 25, an aspect (a shape of the article accommodation region) of the article accommodation region when viewed in the same direction is changed. Accordingly, the aspect of the article accommodation region in a case where the tray 25 is mounted such that the front side faces the cart body 3 side and the aspect of the article accommodation region in a case where the tray 25 is mounted such that the rear side faces the cart body 3 side are different from each other.

In addition, the fence portion 25b does not necessarily have to be installed in the entire area around the bottom plate 25a. As shown in FIG. 20, for example, a configuration can be adopted in which the intermediate bar 25f3 of the first side bar 25f and the intermediate bar 25g3 of the second side bar 25g are omitted. In this case, sides of the tray 25 are open, and thus, the article can be easily put in the tray 25 or taken out from the tray 25.

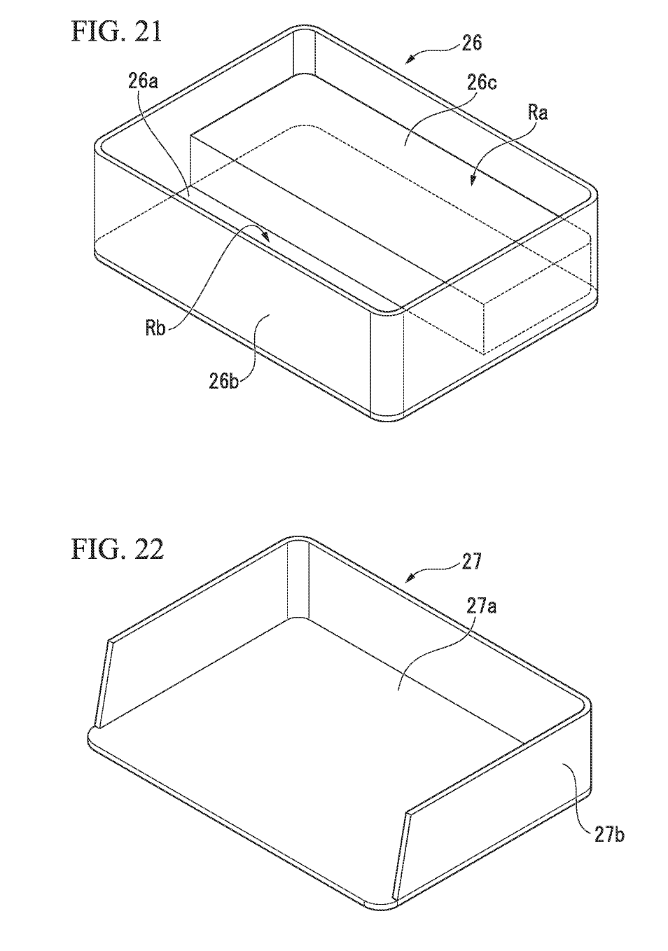

In addition, as shown in FIG. 21, a tray 26 in which a step is provided inside the article accommodation region can be adopted. The tray 26 shown in FIG. 21 includes a bottom plate 26a having a lower surface on which protrusion portions are formed, a peripheral wall 26b which uprightly stands on an edge portion of the bottom plate 26a, and a step portion 26c which is formed in an approximately half region on the bottom plate 26a. In the tray 26, a region in which the step portion 26c is formed becomes a shallow front accommodation region Ra, and a region in which the step portion 26c is not formed becomes a rear accommodation region Rb.

Moreover, as shown in FIG. 22, a tray 27 can be adopted, which include a bottom plate 27a having a lower surface on which protrusion portions are formed and a wall portion 27b in which one side of long sides of the bottom plate 27a is open. According to the tray 27, the article is easily put in the tray 27 or taken out from the tray 27 from the open side of the wall portion 27b. In this tray 27, in a case where the tray 27 is mounted such that a front side thereof faces the cart body 3 and in a case where the tray 27 is mounted such that a rear side thereof faces the cart body 3, a direction in which the open side of the wall portion 27b faces is changed (that is, the aspect of the article accommodation region is changed).

Moreover, the aspect of the article accommodation region in the present invention is not determined by only the depth of the article accommodation region. Not only when the shape of the article accommodation region changes but also when the workability in the same direction to the article accommodation region changes, it can be determined that the aspect of the article accommodation region changes.

In addition, in the embodiment, the configuration in which the shape of the tray 2 in a plan view is approximately rectangular is described. However, the present invention is not limited to this. For example, the shape of the tray 2 in a plan view can he a U shape surrounding the support base 3b from three sides.

Moreover, in the embodiment, the configuration in which the tray 2 can be mounted on the cart body 3 in the front orientation and the rear orientation. However, the present invention is not limited to this. For example, the tray can be mounted in a right orientation and a left orientation, the tray can be mounted in the front orientation and the right orientation or the left orientation, or the tray can be mounted in any one of the front orientation, the rear orientation, the right orientation, and the left orientation.

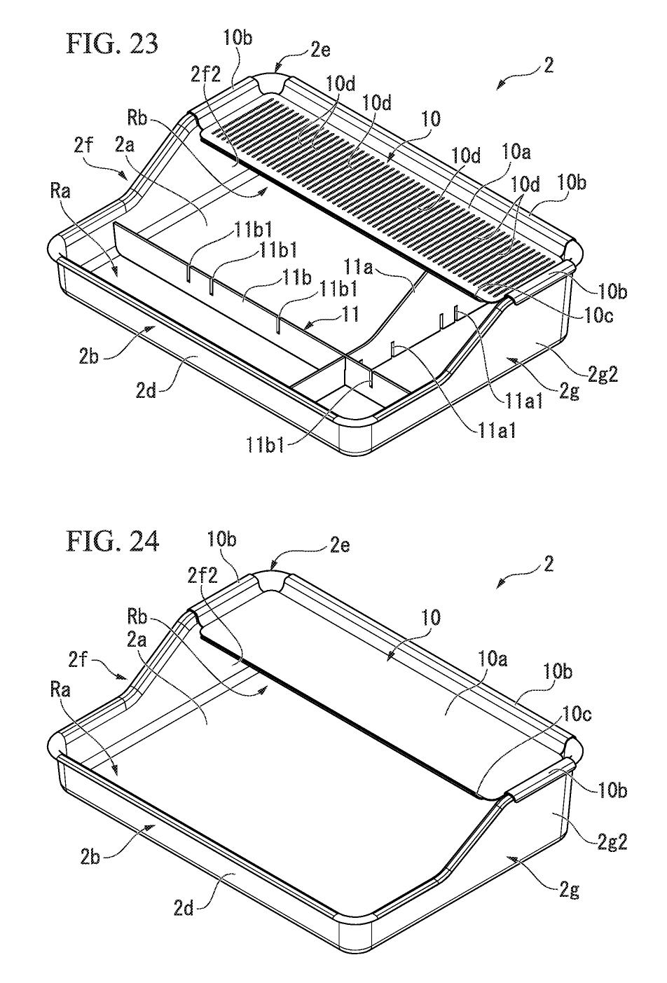

In addition, as shown in FIG. 23, a configuration can be adopted in which a shallow tray 10 is installed on the tray 2 of the embodiment. The shallow tray 10 includes a placing plate 10a on which the article is placed, locking portions 10b which is provided on an edge portion of the placing plate 10a, and a rising portion 10c which prevents the article from falling from the placing plate 10a to the front side of the tray 2.

The placing plate 10a includes a plurality of third slits 10d which are parallel to each other. According to this placing plate 10a, the article positioned below the placing plate 10a can be easily viewed. The locking portions 10b are provided at three locations such as an edge portion positioned on the rear side of the tray 2 of the placing plate 10a, an edge portion positioned on the right side of the tray 2, and an edge portion positioned on the left side of the tray 2. The locking portion 10b provided on the rear edge portion of the tray 2 is locked to the upper end of the rear wall 2e of the tray 2. In addition, the locking portion 10b provided on the right edge portion of the tray 2 is locked to the rear portion 2f2 which is a portion of the first side wall 21f of the tray 2. Moreover, the locking portion 10b provided on the left edge portion of the tray 2 is locked to the rear portion 2g2 which is a portion of the second side wall 2g of the tray 2. The rising portion 10c is formed on the front edge portion of the tray 2 of the placing plate 10a.

As shown in FIG. 23, the locking portions 10b are locked to the tray 2, and thus, the shallow tray 10 is disposed to cover the rear accommodation region Rb of the tray 2 from above. According to this shallow tray 10, it is possible to easily widen the region of the cart device 1 capable of placing the article and it is possible to easily improve usability of the cart device 1. In addition, the shallow tray 10 is installed in the region having a high height in the peripheral wall portion 2b, and thus, the rear accommodation region Rb disposed on the rear side of the tray 2 can be easily viewed from the front side of the tray 2, and it is possible to easily put the article in the rear accommodation region Rb or take out the article therefrom without removing the shallow tray 10.

Moreover, the shallow tray 10 does not necessarily have the third slits 10d. For example, as shown in FIG. 24, the shallow tray 10 in which the third slits 10d are not formed on the placing plate 10a can be adopted.

Moreover, as shown in FIG. 23, a partition plate 11 which partitions the article accommodation region of the tray 2 may be installed. The partition plate 11 includes a first partition plate 11a which extends in the depth direction of the tray 2 and has a length matching a depth of the bottom plate 2a of the tray 2, and a second partition plate 11b which extends in the width direction of the tray 2 and has a length matching a width of the bottom plate 2a of the tray 2. In the first partition plate 11a, a plurality of fourth slits 11a1 having a width matching the thickness of the second partition plate 11b are formed to be separated from each other in the longitudinal direction. In addition, in the second partition plate 11b, a plurality of fifth slits 11b1 having a width matching the thickness of the first partition plate 11a are formed to be separated from each other in the longitudinal direction. The fourth slits 11a1 are formed to reach a lower end of the first partition plate 11a. In addition, the fifth slits 11b1 are formed to reach an upper end of the second partition plate 11b. The first partition plate 11a and the second partition plate 11b are assembled to each other such that the fourth slits 11a1 and the fifth slits 11b1 overlap each other in the vertical direction, and thus, the first partition plate 11a and the second partition plate 11b can be assembled to each other in a cross shape. According to this partition plate 11, the first partition plate 11a and the second partition plate 11b are assembled to each other in a cross shape, and thus, the partition plate 11 can uprightly stand on the bottom plate 2a without supporting the partition plate 11. Therefore, it is possible to partition the article accommodation region merely by placing the partition plate 11 on the bottom plate 2a without processing the tray 2.

### INDUSTRIAL APPLICABILITY

According to the present invention, it is possible to further improve the usability in the cart device on which the article placing area detachably attached to the fixture body is mounted.

According to the present invention, it is possible to flexibly change the aspect in the use condition in the article placing area detachably attached to the fixture body. In addition, the use aspect can be changed by one article placing area, and thus, it is not necessary to prepare the article placing areas having a plurality of shapes, and it is possible to suppress an amount of capital investment by decreasing the number of the molding dies or the like or it is possible to decrease the number of management steps or management cost.

### REFERENCE SIGNS LIST

1: cart device

2, 7, 25, 26, 27: tray (article placing area)

2a, 25a, 26a, 27a: bottom plate

2b: peripheral wall portion

2b1: flange

2d: front wall (front fall prevention portion)

2e: rear wall (rear fall prevention portion)

2f: first side wall

2f1: front portion

2f2: rear portion

2g: second side wall

2g1: front portion

2g2: rear portion

3: cart body

3b: support base

3b4: shelf post

3b6: locking holes

4: tray support mechanism

5: tray unit (article placing area)

6: hanger unit (article placing area)

25b: fence portion

25c: support pillar

25c1: first support pillar

25d: front bar (front fall prevention portion)

25e: rear bar (rear fall prevention portion)

Ra: front accommodation region

Rb: rear accommodation region

1. A cart device which includes a fixture body capable of traveling and an article placing area which is detachably attached to the fixture body,
wherein an orientation of the article placing area with respect to the fixture body is changed and the article placing area is detachably attached to the fixture body, in which an aspect of an article accommodation region when the article placing area is mounted on the fixture body in a first orientation and an aspect of the article accommodation region when the article placing area is mounted on the fixture body in a second orientation different from the first orientation are different from each other, and
wherein the cart device comprises the article placing area which is mounted on the fixture body in the first orientation and the article placing area which is mounted on the fixture body in the second orientation.

2. The cart device according to claim 1,
wherein the fixture body includes
a placing area support mechanism which detachably supports the article placing area, and
a support base which supports the placing area support mechanism and includes attached portions, to which the placing area support mechanism is attached, in front of the support base and behind the support base.

3. The cart device according to claim 2,
wherein the placing area support mechanism is attached to the attached portion such that a position of the placing area support mechanism in a vertical direction is able to be changed.

4. The cart device according to claim 2, further comprising:
a front article placing area which is the article placing area disposed in front of the support base and a rear article placing area which is the article placing area disposed behind the support base, and
wherein a height position of an upper end portion of the front article placing area on the support base side and a height position of an upper end of the rear article placing area are set to be same as each other.

5. The cart device according to claim 1,
wherein the article placing area includes a bottom plate having an upper surface which becomes a placing surface of an article, a front fall prevention portion which uprightly stands on a front edge portion of the bottom plate, and a rear fall prevention portion which uprightly stands on a rear edge portion of the bottom plate and has a height higher than the front fall prevention portion from the bottom plate.

6. The cart device according to claim 5,
wherein the front fall prevention portion and the rear fall prevention portion are configured of a portion of a peripheral wall portion which uprightly stands along an edge portion of the bottom plate, and
wherein the peripheral wall portion includes a side wall having a portion which is connected to the front fall prevention portion and has the same height as a height of the front fall prevention portion and a portion which is connected to the rear fall prevention portion and has the same height as a height of the rear fall prevention portion.

7. An article placing area on which an article is able to be placed,
wherein an orientation of the article placing area with respect to a fixture body is changed and the article placing area is detachably attached to the fixture body, and
wherein an aspect of an article accommodation region when the article placing area is mounted on the fixture body in a first orientation and an aspect of the article accommodation region when the article placing area is mounted on the fixture body in a second orientation different from the first orientation are different from each other.

8. The article placing area according to claim 7,
wherein a front side or a rear side of the article placing area is detachably attached to the fixture body toward the fixture body, and
wherein a depth of a front accommodation region which is a region on the front side of the article accommodation region and a depth of a rear accommodation region which is a region on the rear side of the article accommodation region are different from each other.

9. The article placing area according to claim 8, comprising:
a bottom plate having an upper surface which becomes a placing surface of an article;
a front fall prevention portion which uprightly stands on a front edge portion of the bottom plate; and
a rear fall prevention portion which uprightly stands on a rear edge portion of the bottom plate and has a height higher than the front fall prevention portion from the bottom plate.

10. The article placing area according to claim 9,
wherein the front fall prevention portion and the rear fall prevention portion are configured of a portion of a peripheral wall portion which uprightly stands along an edge portion of the bottom plate.

11. The article placing area according to claim 10,
wherein a flange is formed on an upper end of the peripheral wall portion.
